(19) United States
(12) Patent Application Publication
(10) Pub. No.: US 2017/0124660 A1
(43) Pub. Date: May 4, 2017

(54) Telematics Based Systems and Methods for Determining and Representing Driving Behavior

(71) Applicant: Verizon Patent and Licensing Inc., Arlington, VA (US)

(72) Inventor: Ashok N. Srivastava, Mountain View, CA (US)

(73) Assignee: Verizon Patent and Licensing Inc.

(21) Appl. No.: 14/930,561

(22) Filed: Nov. 2, 2015

(51) Int. Cl. G06Q 40/08; G07C 5/08; G07C 5/02

(52) U.S. Cl. CPC G06Q 40/08; G07C 5/02; G07C 5/08

(57) ABSTRACT

An exemplary method includes a telematics computing system collecting telematics data from a telematics device associated with a vehicle, aggregating the telematics data collected over time from the telematics device associated with the vehicle, analyzing the aggregated telematics data to determine a set of discrete segments of driving behavior associated with the vehicle, classifying the set of discrete segments of the driving behavior associated with the vehicle based on the analyzing of the aggregated telematics data, and generating a representation of the driving behavior based on the classifying of the set of discrete segments of the driving behavior, the representation of the driving behavior including weighting factors assigned to the classified set of discrete segments of the driving behavior.

### BACKGROUND INFORMATION

Telematics technologies have been used by insurance carriers to monitor driving behavior. Insurance carriers use the monitored driving behavior to assess the risk posed by drivers to the insurance carriers and to determine insurance premiums to be charged based on the assessed risk. While telematics based driving behavior helps insurance carriers to accurately assess driver risk, there remains room for improvement in how telematics data is collected and used to determine and represent driving behavior. There also remains room for new or improved ways of applying telematics based driving behavior to benefit drivers and/or insurance carriers.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary insurance churn management system according to principles described herein.

FIGS. 2-5 illustrate exemplary implementations of the insurance churn management system of FIG. 1 according to principles described herein.

FIGS. 6-8 illustrate exemplary graphical user interfaces according to principles described herein.

FIG. 9 illustrates an exemplary flow diagram according to principles described herein.

FIG. 10 illustrates an exemplary insurance churn management method according to principles described herein.

FIG. 11 illustrates an exemplary telematics system according to principles described herein.

FIG. 12 illustrates an exemplary set of classified and weighted discrete segments of driving behavior according to principles described herein.

FIG. 13 illustrates an exemplary telematics based method of determining and representing driving behavior according to principles described herein.

FIG. 14 illustrates an exemplary computing device according to principles described herein.

### DETAILED DESCRIPTION OF PREFERRED EMBODIMENTS

Exemplary telematics based systems and methods for determining and representing driving behavior are described herein. In certain examples described herein, telematics based systems and methods may collect telematics data from a telematics device associated with a vehicle, aggregate the telematics data collected over time from the telematics device associated with the vehicle, analyze the aggregated telematics data to determine a set of discrete segments of driving behavior associated with the vehicle, classify the set of discrete segments of the driving behavior associated with the vehicle based on the analyzing of the aggregated telematics data, and generate a representation of the driving behavior based on the classifying of the set of discrete segments of the driving behavior. The generated representation of the driving behavior may include weighting factors assigned to the discrete segments included in the classified set of discrete segments of the driving behavior. By determining, classifying, and representing discrete segments of driving behavior with weighting factors as described herein, systems and methods described herein may accurately represent the driving behavior of a driver at a granular level, which may facilitate improved accuracy in the representation of the driving behavior.

Such telematics-based, granular, and weighted representations of driving behavior may be used for new and/or improved applications of driving behavior data. For example, such representations of driving behavior may be used to generate accurate risk assessments for drivers and/or to generate accurate insurance premium quotes. In certain examples, such representations of driving behavior may be used to create a new and/or improved insurance marketplace, such as an insurance marketplace that facilitates insurance churn.

“Insurance churn” is an expression that is often used to describe insurance policy holders moving back and forth between insurance carriers. Insurance churn typically favors an insurance policy holder because the insurance policy holder is often able to obtain a lower insurance premium rate by shopping multiple insurance carriers (e.g., by soliciting and comparing insurance price quotes from multiple insurance carriers before switching to another insurance carrier). However, shopping multiple insurance carriers is often time consuming and/or difficult. For example, when an insurance policy holder is contemplating switching from one insurance carrier to another insurance carrier, the insurance policy holder may be required to provide personal information (e.g., accident history, traffic violation history, income information, etc.) to the insurance carrier, which may be time consuming. In addition, the insurance policy holder is typically presented with a great deal of insurance policy information (e.g., coverage options, limitations, pricing information, etc.) that may be difficult to understand and may require a significant amount of time to sift through and compare with insurance policy information provided by other insurance carriers. Moreover, insurance churn is costly for insurance carriers, not only because the insurance carriers lose a paying insurance policy holder but also because it is more expensive to write an insurance policy for a new insurance policy holder than it is to retain a current insurance policy holder. As a result, insurance carriers typically take various measures to attempt to prevent or at least make it difficult for insurance policy holders to switch to a different insurance carrier. The end result is that insurance policy holders typically find the process associated with insurance churn to be time consuming and/or unpleasant. In view of the amount of work associated with insurance churn, insurance policy holders typically stay with the same insurance carrier for years, even when there are better and/or lower cost insurance policy options available.

Exemplary insurance churn management systems and methods are described herein. Certain systems and methods described herein may facilitate insurance churn. As used herein, “insurance churn” refers to the switching of insurance coverage from being provided to an insurance policy holder by an insurance carrier to being provided to the insurance policy holder by another insurance carrier. To facilitate insurance churn, certain systems and methods described herein may access insurance parameter data and/or detect changes in insurance parameter data. For example, an insurance churn management system may access, from a plurality of data sources, insurance parameter data associated with an insurance policy holder. In certain examples, the plurality of data sources may include a tracking device associated with the insurance policy holder. Based on the accessed insurance parameter data, the insurance churn management system may group the insurance policy holder into an actuarial risk group included in a plurality of actuarial risk groups. Based on the actuarial risk group, the insurance churn management system may determine that a first insurance carrier offers a first insurance premium that is less than a second insurance premium currently paid by the insurance policy holder and associated with a second insurance carrier. The insurance churn management system may provide, for display in a graphical user interface on a display screen of a computing device, a price quote associated with the first insurance premium together with a graphical object configured to be selected by the insurance policy holder to invoke a one-click switch of insurance coverage from being provided to the insurance policy holder by the second insurance carrier to being provided to the insurance policy holder by the first insurance carrier. The insurance churn management system may detect a selection of the graphical object by the insurance policy holder. Based on the detected selection of the graphical object, the insurance churn management system may facilitate automatically switching the insurance coverage from being provided to the insurance policy holder by the second insurance carrier to being provided to the insurance policy holder by the first insurance carrier.

Various benefits may be realized in accordance with the systems and methods described herein. For example, exemplary systems and methods described herein may facilitate convenient, efficient, and/or cost-effective insurance churn. In addition, certain systems and methods described herein may effectively promote competition among various insurance carriers, which may result in lower insurance premium costs to insurance policy holders. Moreover, certain systems and methods described herein may facilitate one or more background operations to interact with application programming interfaces associated with insurance carriers, insurance churn service providers, and/or other entities (e.g., entities such as a cellular telephone and/or data service provider, a subscription television service provider, a telematics service provider, etc.) to transparently facilitate insurance churn. These and/or additional or alternative benefits that may be provided by exemplary systems and methods described herein will be made apparent by the following description. Exemplary insurance churn management systems and methods will now be described in reference to the accompanying drawings.

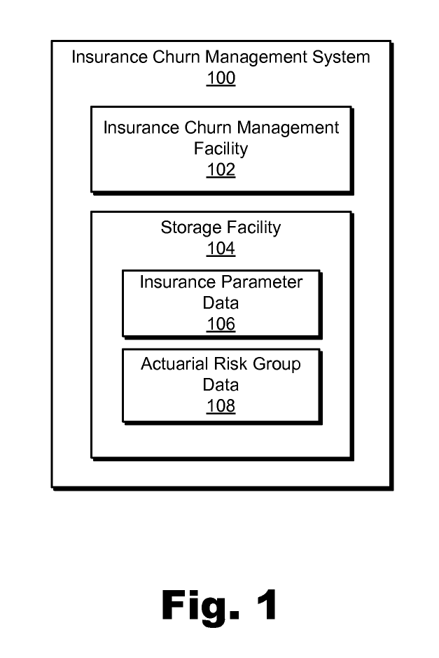

FIG. 1 illustrates an exemplary insurance churn management system 100 (“system 100”). System 100 may perform one or more of the operations described herein to facilitate insurance churn. As shown in FIG. 1, system 100 may include, without limitation, an insurance churn management facility 102 (“management facility 102”) and a storage facility 104 selectively and communicatively coupled to one another. Facilities 102 and 104 may be communicatively coupled one to another by any suitable communication technologies.

It will be recognized that although facilities 102 and 104 are shown to be separate facilities in FIG. 1, the facilities 102 and 104 may be combined into a single facility or split into additional facilities as may serve a particular implementation. Additionally or alternatively, one or more of the facilities 102 and 104 may be omitted from and external to system 100 in other implementations. For example, storage facility 104 may be external of system 100 in some alternative implementations. Facilities 102 and 104 will now be described in more detail.

Storage facility 104 may store insurance parameter data 106 representative of information associated with an insurance policy holder and/or an insurance policy carried by the insurance policy holder that may be used by system 100 to facilitate the insurance policy holder switching from one insurance carrier to another insurance policy carrier. For example, insurance parameter data 106 may include data that describes the insurance policy holder and/or certain attributes, operations, and/or statuses of objects and/or locations covered by an insurance policy of the insurance policy holder. Examples of data that may be stored as insurance parameter data 106 are described herein. Storage facility 104 may also store actuarial risk group data 108 representative of one or more actuarial risk groups to which an insurance policy holder may be grouped. Storage facility 104 may maintain additional or alternative data as may serve a particular implementation.

Management facility 102 may perform one or more operations associated with facilitating a switch of insurance coverage for a policy holder from being provided by an insurance carrier to being provided by another insurance carrier. Prior to the facilitating of the switch, management facility 102 may register an insurance policy holder with an insurance churn service that may be provided by management facility 102. As used herein, “an insurance churn service” refers to a computer-based service that facilitates insurance churn, such as by facilitating an insurance policy holder to switch from having insurance coverage provided by an insurance carrier to having insurance coverage provided by another insurance carrier. The insurance churn service may be associated with any type of insurance or combination of insurances that may be associated with the insurance policy holder. For example, the insurance churn service may be associated with vehicular insurance (e.g., automobile insurance, motorcycle insurance, etc.), home insurance, life insurance, health insurance, and/or any other type of insurance that may be carried or otherwise associated with the insurance policy holder. Specific examples of how the systems and methods described herein may be applied to various types of insurance are provided herein.

Management facility 102 may register the insurance policy holder with the insurance churn service in any suitable manner. For example, management facility 102 may solicit and receive from the insurance policy holder preliminary insurance parameter data that may be used in any suitable manner to provide insurance price quotes to the insurance policy holder. For example, the preliminary insurance parameter data may include a name of the insurance policy holder, a gender of the insurance policy holder, an age of the insurance policy holder, an address of the insurance policy holder, a marital status of the insurance policy holder, an education status of the insurance policy holder, a social security number of the insurance policy holder, license information of the insurance policy holder, an employment status/occupation of the insurance policy holder, and/or any other suitable information that may be associated with the insurance policy holder. Additionally or alternatively, the preliminary insurance parameter data may include information associated with a current insurance policy of the insurance policy holder. For example, management facility 102 may receive information from the insurance policy holder identifying the insurance carrier associated with the current insurance policy, a price of the current insurance policy, coverage associated with the current insurance policy, and/or any other suitable information associated with the current insurance policy. Management facility 102 may direct storage facility 104 to store the preliminary insurance parameter data as insurance parameter data 106.

As part of the registration, the insurance policy holder may agree to allow management facility 102 to access, over time, insurance parameter data associated with the insurance policy holder to be used for any suitable purpose, such as described herein. Based on the agreement, management facility 102 may access, from a plurality of data sources, the insurance parameter data associated with the insurance policy holder. The insurance parameter data may include any suitable data associated with the insurance policy holder. For example, the insurance parameter data may include any update and/or change to the preliminary insurance parameter data described above. Additionally or alternatively, the insurance parameter data may include telematics data (e.g., vehicle make/model, miles driven, location, driver behavior, etc.), credit report data, mobile communications subscriber information (e.g., data plan information, subscriber contract information, credit classification, demographic information, click stream data, etc.), weather data, mobility data, navigation data, and/or any other suitable insurance parameter data that may be associated with the insurance policy holder and/or an insurance policy carried by the insurance policy holder.

Management facility 102 may access the insurance parameter data from any suitable data source and in any suitable manner. For example, the plurality of data sources may include, but are not limited to, credit reporting agencies, insurance risk exchange databases (e.g., LEXISNEXIS databases), tracking devices (e.g., telematics devices, Internet of Things (“IoT”) devices, etc.), mobile communication service subscriber data sources, weather data sources, mobility data sources, navigation data sources, insurance carriers, and/or any other suitable data source. To illustrate, after registration, management facility 102 may access insurance parameter data from a first data source, a second data source, and a third data source. The insurance parameter data accessed from one or more of the first data source, the second data source, and the third data source may indicate or otherwise be associated with the insurance policy holder and/or an insurance policy carried by the insurance policy holder. Management facility 102 may direct storage facility 104 to store the accessed insurance parameter data as insurance parameter data 106. Specific examples of data sources and how management facility 102 may communicate with the data sources are described herein.

Based on the accessed insurance parameter data, management facility 102 may group the insurance policy holder into an actuarial risk group included in a plurality of actuarial risk groups. As used herein, an “actuarial risk group” may be defined by a particular insurance parameter data set and may include insurance policy holders that each have similar insurance parameter data sets to the particular insurance parameter data set. For example, an insurance policy holder may be associated with an insurance parameter data set indicating that the insurance policy holder is associated with a relatively high level of risk to insure. Such an insurance policy holder may be grouped in an actuarial risk group with other insurance policy holders that are associated with similar insurance parameter data sets.

Management facility 102 may group an insurance policy holder in an actuarial risk group in any suitable manner. For example, management facility 102 may analyze the insurance parameter data associated with the insurance policy holder and compare the insurance parameter data to insurance parameter data sets that define a first actuarial risk group, a second actuarial risk group, and a third actuarial risk group. Based on the comparison, management facility 102 may determine that the insurance policy holder should be grouped in one of the first actuarial risk group, the second actuarial risk group, and the third actuarial risk group. Each of the plurality of actuarial risk groups may be associated with an insurance price quote or insurance price quote range specific to the actuarial risk group.

In certain examples, the actuarial risk group to which an insurance policy holder may be grouped may change over time as management facility 102 accesses additional insurance parameter data. To illustrate, an insurance policy holder may initially be grouped in a first actuarial risk group based on insurance parameter data accessed by management facility 102. Over time, management facility 102 may access additional insurance parameter data from any suitable data source. The additional insurance parameter data may indicate that the insurance policy holder is now associated with a relatively lower level of insurance risk (e.g., as a result of being a safer driver, a more responsible homeowner, a healthier individual, etc.). Based on the additional insurance parameter data, management facility 102 may determine that the insurance policy holder should be grouped in a second actuarial risk group instead of the first actuarial risk group, which may result in a lower cost insurance premium for the insurance policy holder.

In certain examples, management facility 102 may build and/or define actuarial risk groups based on accessed insurance parameter data associated with a plurality of insurance policy holders. To this end, management facility 102 may define and/or use one or more risk models based on information accessible to management facility 102, and build the actuarial risk groups based on the risk models. In certain examples, the risk models and/or risk groups may be highly accurate at least because of the quantifiable information to which management facility 102 has access. Alternatively, management facility 102 may access pre-generated actuarial risk groups built and/or defined, for example, by one or more insurance carriers and/or a third party.

Based on an actuarial risk group, management facility 102 may determine that a first insurance carrier offers a first insurance premium that is less than a second insurance premium currently paid by an insurance policy holder and associated with a second insurance carrier. This may be accomplished in any suitable manner. For example, management facility 102 may map the determined actuarial risk group with an insurance quote database that includes price quote information. In certain examples, the insurance quote database may be maintained by one or more insurance carriers and/or a third party. In such examples, management facility 102 may communicate with the one or more insurance carriers and/or the third party in any suitable manner to access the insurance quote database. Alternatively, management facility 102 may maintain the insurance quote database based on information obtained from one or more insurance carriers and/or a third party. Management facility 102 may compare a price quote associated with the determined actuarial risk group with an insurance premium currently paid by the insurance policy holder to determine whether the price quote would result in a lower cost insurance premium for the insurance policy holder. In certain examples, management facility 102 may determine that a plurality of insurance carriers offer insurance premiums that are less than an insurance premium currently being paid by the insurance policy holder.

After management facility 102 determines that an insurance carrier offers an insurance premium that is less than an insurance premium currently paid by the insurance policy holder, management facility 102 may provide a price quote to the insurance policy holder. In certain examples, the price quote may be a guaranteed price quote. For example, prior to management facility 102 providing the price quote to the insurance policy holder, management facility 102 may confirm, in any suitable manner, that one or more insurance carriers are willing to provide insurance coverage at or below a specific price.

In certain examples, management facility 102 may utilize mobile communications subscriber information to provide the price quote associated with the first insurance premium. Such mobile communications subscriber information may include information related to an insurance policy holder's interaction with a mobile communications subscriber service (e.g., a mobile phone service). For example, the mobile communications subscriber information may include click stream data including a log of Internet browsing activity on a smart phone of the insurance policy holder. Such click stream data may indicate certain likes and/or interests of the insurance policy holder. For example, the click stream data may indicate that the insurance policy holder recently visited a website associated with a particular insurance carrier. Management facility 102 may utilize that information to provide a price quote to the insurance policy holder. In another example, the mobile communications subscriber information may indicate that the insurance policy holder consistently pays mobile communications service bills on time. Such an attribute of the insurance policy holder may result in management facility 102 providing a relatively lower price quote to the insurance policy holder than would be provided to another insurance policy holder that, for example, may not be as consistent with paying mobile communications service bills. Management facility 102 may utilize additional or alternative mobile communications subscriber information to provide a price quote in other implementations.

When management facility 102 utilizes mobile communications subscriber information to provide a price quote, certain benefits may be provided to an insurance policy holder and/or an insurance carrier. Such benefits to the insurance policy holder may include, for example, a decrease in an amount paid by the insurance policy holder for insurance coverage. Such benefits to the insurance carrier may include, for example, use of quantifiable information to facilitate the insurance carrier assessing risk associated with a particular insurance policy holder. This may, in turn, allow management facility 102 to provide a more competitive price quote from the insurance carrier than other insurance carriers that may not have access to the mobile communications subscriber information. To illustrate an example, the mobile communications subscriber information may include information indicative of whether an insurance policy holder operates a mobile communications device while operating a vehicle. For example, such information may indicate whether the insurance policy holder sends text messages while operating the vehicle, which may be dangerous to the insurance policy holder and/or others. The information associated with how often the insurance policy holder sends text messages while operating the vehicle may provide quantifiable information that the insurance carrier may use to assess the risk associated with insuring the insurance policy holder. For example, if the mobile communications subscriber information indicates that the insurance policy holder rarely or never sends texts while operating the vehicle, the insurance carrier may assign a lower level of insurance risk to the insurance policy holder, which may result in management facility 102 providing a relatively lower price quote to the insurance policy holder for insurance coverage. In addition, the insurance policy holder may be motivated to not text while operating the vehicle in order to receive a better insurance rate, which in turn may also increase the safety of the insurance policy holder and/or others.

When management facility 102 utilizes mobile communications subscriber information to provide a price quote, certain technical benefits may be provided to an insurance policy holder and/or an insurance carrier. For example, an insurance carrier may conserve resources by relying on management facility 102 rather than dedicating computing resources to acquire information about the policy holder in different ways, such as by distributing and tracking dedicated telematics devices. An insurance policy holder may also conserve resources by relying on management facility 102 to provide useful information to an insurance carrier instead of the insurance policy holder having to use time and/or personal computing resources to provide such information. In addition, the quantifiable information provided by management facility 102 may be more reliable than other information such as information manually provided by an insurance policy holder.

Management facility 102 may provide the price quote to the insurance policy holder in any suitable manner. For example, management facility 102 may provide the price quote for display in a graphical user interface on a display screen of a computing device associated with the insurance policy holder. The computing device may include any suitable computing device that may be configured to provide a price quote to an insurance policy holder. For example, the computing device may include, but is not limited to, a mobile phone, a smart phone, a tablet computer, a laptop computer, a desktop computer, and/or any other computing device as may serve a particular implementation. Exemplary graphical user interfaces that may be presented to an insurance policy holder are described herein.

In certain examples, the price quote may be provided for display together with a graphical object configured to be selected by the insurance policy holder to invoke a one-click switch of insurance coverage from being provided to the insurance policy holder by the second insurance carrier to being provided to the insurance policy holder by the first insurance carrier. As used herein, the expression “one-click switch of insurance coverage” means that, once the insurance policy holder selects the graphical object, no further action or input is required of the insurance policy holder to switch insurance coverages. That is, the insurance policy holder is not required to provide information, contact, or otherwise interact in any way with either the first or the second insurance carriers prior to the switch of insurance coverage. In certain examples, the one-click switch of insurance coverage may result in an automatic and instantaneous switch of insurance coverage at the time of the selection of the graphical object. Alternatively, the one-click switch of insurance coverage may result in the insurance coverage being switched after expiration of a predetermined amount of time (e.g., after expiration of the insurance policy provided by the second insurance carrier or after a predetermined wait period). Exemplary graphical objects that may be provided for display to the insurance policy holder are described herein.

In certain examples, management facility 102 may provide, for display in the graphical user interface together with the price quote, a notification of the second insurance premium currently paid by the insurance policy holder and associated with the second insurance carrier. Management facility 102 may provide the notification for display in any suitable manner. For example, management facility 102 may provide the notification for display adjacent to the price quote and graphical object to facilitate a quick comparison by the insurance policy holder. Such a notification may include any other suitable information that may help the insurance policy holder decide whether to switch insurance carriers. Exemplary notifications are described herein.

After management facility 102 provides the graphical object for display in the graphical user interface, management facility may detect a selection of the graphical object by the insurance policy holder. Management facility 102 may detect the selection of the graphical object by the insurance policy holder in any suitable manner. For example, management facility 102 may detect a touch input on a touch screen of the computing device associated with the user. Based on the detected touch input, management facility 102 may determine that the insurance policy holder has selected the graphical object. Additionally or alternatively, management facility 102 may detect the selection through any other suitable user input device.

Based on the detected selection of the graphical object, management facility 102 may automatically facilitate a switch of the insurance coverage from being provided to the insurance policy holder by the second insurance carrier to being provided to the insurance policy holder by the first insurance carrier. Management facility 102 may automatically facilitate the switch in any suitable manner. For example, after the selection of the graphical object, management facility 102 may automatically perform one or more background operations to facilitate the switch. Such one or more background operations may include any suitable background operation that securely facilitates the switch and that does so in a manner that is transparent to the insurance policy holder. For example, the one or more background operations may include management facility 102 notifying the second insurance carrier that the insurance policy holder has canceled the insurance coverage provided by the second insurance carrier (e.g., by sending a notification to a computing system operated by the second insurance carrier). In addition, the one or more background operations may include management facility 102 instructing the first insurance carrier to provide insurance coverage to the insurance policy holder (e.g., by sending one or more instructions to a computing system operated by the first insurance carrier).

In certain examples, the one or more background operations may include management facility 102 providing insurance payment processing information to the first insurance carrier. For example, management facility 102 may provide credit card information, direct withdrawal information, and/or any other suitable insurance payment processing information to the first insurance carrier to ensure that the insurance coverage is in place as a result of the selection of the graphical object by the insurance policy holder. In certain examples, management facility 102 may have access to payment processing information on file with a mobile communications service. For example, such payment processing information may include direct withdrawal information used to automatically pay monthly mobile phone bills. In such examples, the providing of the payment processing information may include management facility 102 providing the payment processing information on file with the mobile communications service provider to the insurance carrier for use in processing payment of insurance premiums. In certain examples, the providing of the insurance payment processing information to the first insurance carrier by management facility 102 may be transparent to the insurance policy holder in that a payment associated with the insurance churn is automatically processed by management facility 102 without the insurance policy holder having to perform any payment action (e.g., cutting a check, setting up direct payment withdrawal, etc.).

In certain examples, the insurance policy holder may be entitled to a refund of an insurance premium as a result of a cancellation of insurance coverage provided by the second insurance carrier. Accordingly, in certain examples, the one or more background operations may include management facility 102 facilitating processing a refund of an insurance premium. Management facility 102 may facilitate processing of the refund in any suitable manner. For example, management facility 102 may receive the refund from the second insurance carrier and provide, for example, either an account credit or mail a refund check to the insurance policy holder. Alternatively, management facility 102 may direct the second insurance carrier to provide the refund directly to the insurance policy holder by way of, for example, a mailed check or a credit to a deposit account associated with the insurance policy holder.

In certain examples, the one or more background operations may include management facility 102 instructing the first insurance carrier to provide or otherwise make available insurance policy documents (e.g., insurance cards, insurance coverage information, etc.) to the insurance policy holder. Management facility 102 may perform any other suitable background operations in other implementations.

The one or more background operations may include management facility 102 interacting with one or more application programming interfaces of one or more computing systems operated by insurance carriers, insurance churn service providers, and/or other entities to transparently facilitate insurance churn.

After the switch of the insurance coverage, management facility 102 may provide, for display in the graphical user interface, a notification that the insurance policy holder has an insurance policy with the first insurance carrier. Management facility 102 may provide the notification in any suitable manner. For example, subsequent to the insurance policy holder selecting the graphical object, management facility 102 may provide a text notification for display in the graphical user interface that indicates that the insurance policy holder now has an insurance policy with the first insurance carrier. Exemplary notifications indicating a switch in insurance carriers are provided herein.

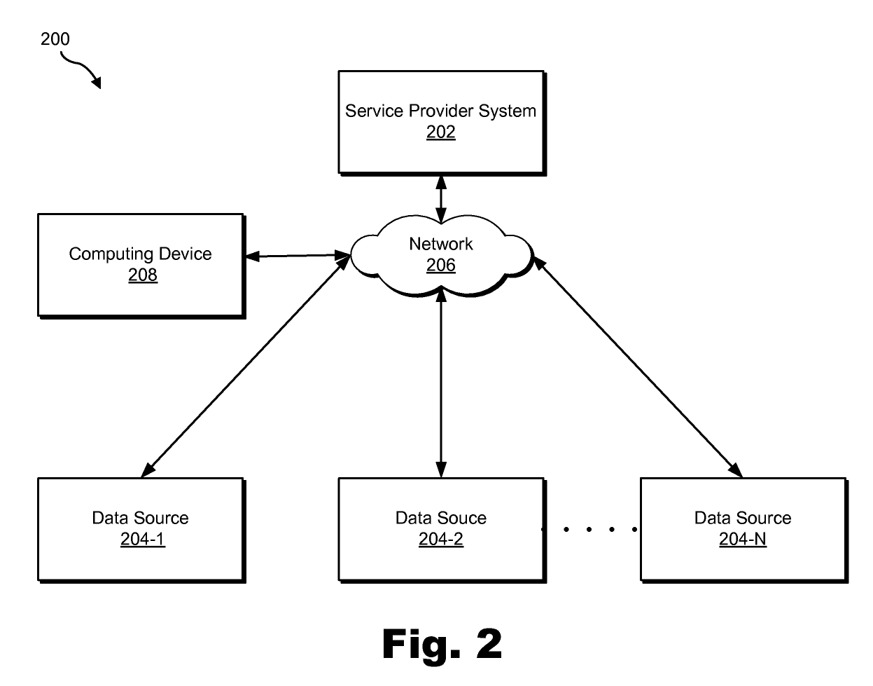

Management facility 102 may communicate with one or more data sources and/or other devices or systems in any suitable manner. To illustrate, FIG. 2 shows an exemplary implementation 200 of system 100 wherein a service provider system 202 is communicatively coupled to data sources 204 (e.g., data sources 204-1 through 204-N) by way of network 206. As shown in FIG. 2, service provider system 202 is also communicatively coupled to a computing device 208 by way of network 206. Management facility 102 and storage facility 104 may each be implemented by service provider system 202, one or more of data sources 204, and/or computing device 208. Accordingly, in certain embodiments, components of system 100 may be implemented entirely by service provider system 202, by one or more of data sources 204, or by computing device 208. In other embodiments, components of system 100 may be distributed across service provider system 202, data sources 204, and computing device 208.

Service provider system 202 may be associated with a service provider (e.g., an insurance churn service provider, a subscriber television service provider, an Internet service provider, a mobile communications service provider, etc.) and/or any other type of service provider. Accordingly, service provider system 202 may be configured to provide one or more services (e.g., insurance churn services, mobile communications services, television services, video-on-demand services, Internet services, application services, etc.) to computing devices (e.g., computing device 208). Service provider system 202 may be implemented by one or more computing devices (e.g., server computing devices) as may serve a particular implementation. Service provider system 202 may manage insurance parameter data, interface with one or more application programming interfaces associated with one or more insurance carriers, and/or perform any other operation associated with the methods and systems described herein.

Service provider system 202, data sources 204, and computing device 208 may communicate using any communication platforms and technologies suitable for transporting data (e.g., insurance parameter data) and/or communication signals, including known communication technologies, devices, media, and protocols supportive of remote communications, examples of which include, but are not limited to, data transmission media, communications devices, Transmission Control Protocol (“TCP”), Internet Protocol (“IP”), HTTP, Hypertext Transfer Protocol Secure (“HTTPS”), Session Initiation Protocol (“SIP”), Simple Object Access Protocol (“SOAP”), Extensible Mark-up Language (“XML”) and variations thereof, Real-Time Transport Protocol (“RTP”), User Datagram Protocol (“UDP”), Long Term Evolution (“LTE”) technologies, Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), Radio Frequency (“RF”) signaling technologies, wireless communication technologies, Internet communication technologies, and other suitable communications technologies.

In certain embodiments, service provider system 202, data sources 204, and computing device 208 may communicate via network 206. Network 206 may include one or more networks, such as one or more wireless networks (Wi-Fi networks), wireless communication networks, mobile telephone networks (e.g., cellular telephone networks), closed media networks, open media networks, closed communication networks, open communication networks, wide area networks (e.g., the Internet), local area networks, and any other networks capable of carrying data (e.g., transmitting insurance parameter data) and/or communications signals between service provider system 202, data sources 204, and computing device 208. Communications between service provider system 202, data sources 204, and computing device 208 may be transported using any one of the above-listed networks, or any combination or sub-combination of the above-listed networks. Alternatively, service provider system 202, data sources 204, and computing device 208 may communicate in another way such as by direct connections between service provider system 202, data sources 204, and computing device 208.

Computing device 208 may be associated with (e.g., owned and/or operated by) an insurance policy holder and may include any suitable computing device, such as described herein. Although FIG. 2 only illustrates one computing device 208, it is understood that a plurality of computing devices, which may be associated with a plurality of insurance policy holders, may communicate with service provider system 202 by way of network 206.

Data sources 204 may include any suitable data sources, such as described herein, that may provide insurance parameter data and/or any other suitable information to service provider system 202 and/or computing device 208.

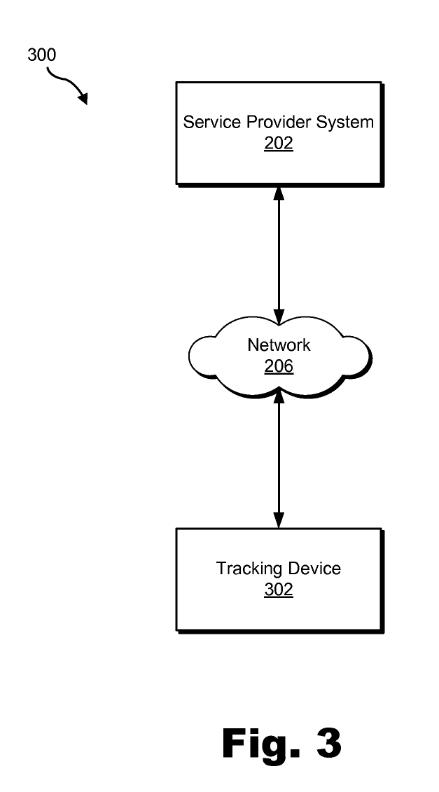

In certain examples, one or more of data sources 204 may include a tracking device. As used herein, a “tracking device” refers to any device that may be configured to track, over time, insurance parameter data associated with an insurance policy holder. A tracking device may detect any suitable information associated with an insurance policy holder that may be used as insurance parameter data. For example, a tracking device may detect behavior of the insurance policy holder (e.g., driver behavior, travel patterns, activity patterns, etc.) and/or certain attributes of one or more objects and/or locations associated with the insurance policy holder. Management facility 102 may access such insurance parameter data from a tracking device in any suitable manner. To illustrate, FIG. 3 shows an implementation 300 in which a tracking device 302 communicates with service provider system 202 by way of network 206.

In certain examples, tracking device 302 may include a telematics device that monitors one or more operational parameters of a vehicle associated with the insurance policy holder (e.g., a vehicle operated by the insurance policy holder). As used herein, a “telematics device” refers to any device that may be configured to track the operation of a vehicle and/or operator behavior. Use of a telematics device to track the operation of a vehicle and/or operator behavior may promote and/or improve efficient and safe operation of the vehicle. For example, when an insurance policy holder knows that a telematics device is associated with a vehicle, the insurance policy holder may be encouraged to operate the vehicle in a reserved manner, which may increase fuel efficiency and/or reduce repairs to the vehicle. In addition, operating the vehicle in such a manner may result in an increase in safety to the vehicle and/or other vehicles.

In certain examples, a telematics device may be a dedicated telematics device that is communicatively coupled to an operating system of a vehicle. A dedicated telematics device may have sole functionality to track and provide insurance parameter data. A dedicated telematics device may connect directly to an operating system of a vehicle or may be integrated with the vehicle (e.g., may be included as part of the operating system when the vehicle is manufactured). In such examples, after registration with the insurance churn service, the insurance policy holder may either activate the integrated telematics device or receive a dedicated telematics device to be installed in the vehicle (e.g., physically connected to an operating system of the vehicle).

Alternatively, a telematics device may include a mobile communications device (e.g., a handheld or wearable mobile communications device) associated with the insurance policy holder. For example, the mobile communications device may include a smart phone of the insurance policy holder that may be configured to operate as a telematics device. When the telematics device includes a mobile communications device such as a smart phone, management facility 102 may prompt the insurance policy holder, in any suitable manner, to install a mobile application that configures the mobile communications device to operate as a telematics device.

A telematics device may monitor and/or store (e.g. in a storage device of the telematics device) any suitable insurance parameter data to be used by management facility 102 to determine a level of risk associated with the vehicle and/or operation of the vehicle. For example, a telematics device may monitor actual miles driven, types of roads traveled (e.g., low risk roads, high risk roads, etc.), safe or unsafe operation of the vehicle by monitoring, for example, speeds driven, safety equipment used (e.g., seat belts, turn signals, etc.), time of day driven, rate of acceleration, rate of braking (i.e., deceleration), observation of traffic signs (e.g., stop lights, stop signs, etc.), operator behavior during traffic conditions (e.g., during low traffic conditions, high traffic conditions, etc.), road conditions (e.g., bumpy conditions, wet conditions, snowy conditions, icy conditions, etc.), acceleration events, deceleration events, lateral acceleration or any other characteristic indicative of a hard turning maneuver, driver identification, and/or any other suitable information that may be used by management facility 102 as insurance parameter data. The telematics device may monitor such insurance parameter data by utilizing any suitable sensor(s). For example, the telematics device may utilize powertrain sensors, safety sensors, acceleration sensors, etc. of the vehicle to collect insurance parameter data. Additionally or alternatively, the telematics device may utilize specific sensors of the telematics device itself such as, for example, one or more accelerometers, magnetometers, proximity sensors, light sensors, gyroscopes, barometers etc. to collect insurance parameter data.

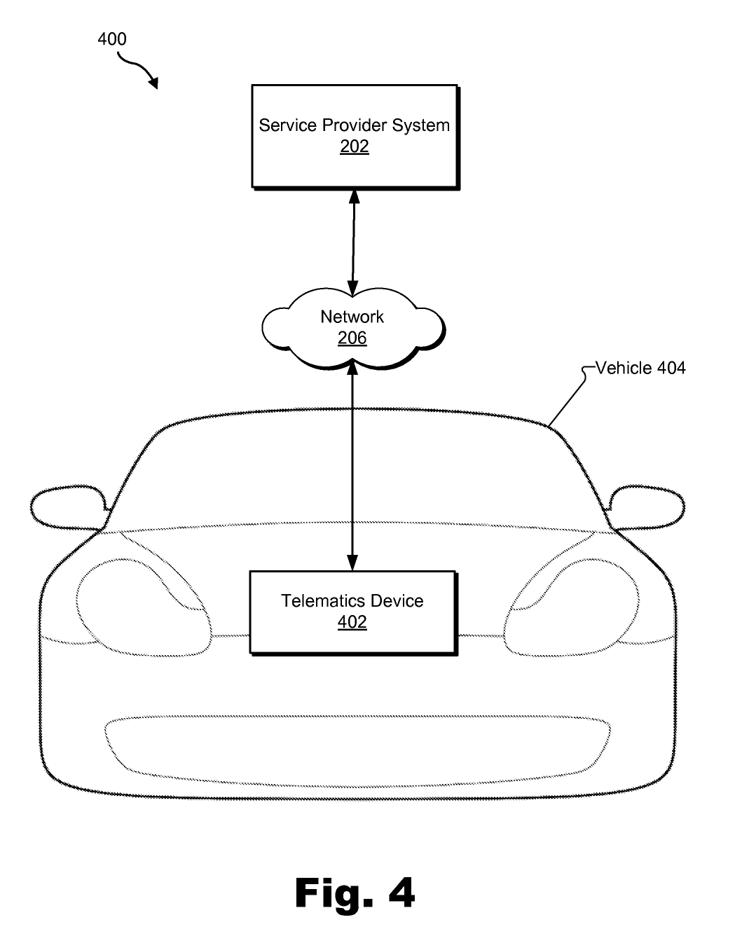

Management facility 102 may access insurance parameter data from a telematics device in any suitable manner. To illustrate, FIG. 4 shows an implementation 400 in which a telematics device 402 is installed in or is otherwise associated with an exemplary vehicle 404. As shown in FIG. 4, telematics device 402 communicates with service provider system 202 by way of network 206. Management facility 102 may access the insurance parameter data from telematics device 402 at any suitable time. In certain examples, management facility 102 may access the insurance parameter data from telematics device 402 continually during operation of vehicle 404. Alternatively, management facility 102 may access the insurance parameter data at predetermined times from a storage device associated with telematics device 402.

Management facility 102 may utilize the insurance parameter data accessed from telematics device 402 in any suitable manner to facilitate switching insurance carriers that provide vehicular insurance coverage to the insurance policy holder. To illustrate an example, when the insurance policy holder initially registers with the insurance churn service, the insurance policy holder may have vehicular insurance coverage provided by an insurance carrier. The vehicular insurance coverage provided by the insurance carrier may be based on the insurance policy holder being initially grouped in a first actuarial risk group. After registration, telematics device 402 may monitor one or more operational parameters of vehicle 404. While telematics device 402 monitors one or more operational parameters of vehicle 404, the insurance policy holder may operate vehicle 404 in a manner that indicates that the insurance policy holder is associated with a relatively lower insurance risk. For example, telematics device 402 may monitor the one or more operational parameters for a predetermined amount of time (e.g., a week, a month, six months, etc.). During the predetermined amount of time, telematics device 402 may record, for example, speed limit compliance information indicating that the insurance policy holder consistently travels at or below prescribed speed limits when operating vehicle 404.

Management facility 102 may access the speed limit compliance information from telematics device 402 at any suitable time and determine that the insurance policy holder is associated with a relatively lower insurance risk. Based on such a determination, management facility 102 may group the insurance policy holder into a second actuarial risk group. Management facility 102 may determine, based on the insurance policy holder now being grouped in the second actuarial risk group, that an additional insurance carrier offers a vehicular insurance premium that is less than the vehicular insurance premium currently paid by the insurance policy holder to the insurance carrier. Management facility 102 may then provide, for display in a graphical user interface on a display screen of a computing device, a price quote associated with the vehicular insurance premium together with a graphical object configured to be selected by the insurance policy holder to invoke a one-click switch of vehicular insurance coverage. Based on a selection of the graphical object by the insurance policy holder, management facility 102 may automatically facilitate a switch of the vehicular insurance coverage from being provided to the insurance policy holder by the insurance carrier to being provided to the insurance policy holder by the additional insurance carrier. For example, in response to the selection, management facility 102 may perform a background operation to inform the insurance carrier that the insurance policy holder is canceling the vehicular insurance policy provided by the insurance carrier. Management facility 102 may also, in a manner that is transparent to the insurance policy holder, instruct the additional insurance carrier to provide vehicular insurance coverage to the insurance policy holder such that vehicle 404 is covered by the additional insurance carrier instead of the insurance carrier. In so doing, the insurance policy holder may, upon selection of the graphical object, instantaneously switch insurance carriers without requiring further action by the insurance policy holder (e.g., without the insurance policy holder having to provide information to either insurance carrier, complete additional paperwork, contact the either insurance carrier, and/or provide payment processing information to the additional insurance carrier).

Vehicle 404 illustrated in FIG. 4 is provided for illustrative purposes only. It is understood that telematics device 402 may be installed in or otherwise associated with any suitable vehicle or machine that may be operated by the insurance policy holder.

Returning to FIG. 3, in certain examples, tracking device 302 may include one or more IoT devices. The Internet of Things may be thought of as a network of smart objects having identifiable virtual representations. Each smart object that is capable of communicating may be considered as an IoT device included in the Internet of Things. As used herein, “an IoT device” refers to any device capable of receiving and/or providing information, such as insurance parameter data. For example, an IoT device may include a mobile phone (e.g., a smart phone), a computing device (e.g., a desktop computer, a laptop computer, a tablet computer, a handheld computer, a camera, an audio recorder, a camcorder, etc.), an appliance (e.g., a refrigerator, a microwave, a stove, etc.), a medical device, a car, a fixture (e.g., a door lock, a window lock, a fireplace, a light bulb, a smoke detector, a carbon monoxide detector, a fire sprinkler, etc.), a physical feature (e.g., tile, woodwork, etc. that include a smart object), and/or any other suitable device.

In certain examples, the one or more IoT devices may be provided to the insurance policy holder by a service provider and/or a third party for the specific purpose of monitoring insurance parameter data. Additionally or alternatively, management facility 102 may utilize existing devices as IoT devices to access insurance parameter data.

In certain examples, the one or more IoT devices may be associated with an insurance policy holder premises of the insurance policy holder. As used herein, “an insurance policy holder premises” may refer to any structure, location, equipment, etc. or combination thereof that may be covered by an insurance policy of the insurance policy holder. For example, an insurance policy holder premises may include a home of the insurance policy holder. The one or more IoT devices may monitor one or more premises parameters associated with the insurance policy holder premises. Such premises parameters may include any suitable parameter that may be utilized by management facility 102 to facilitate insurance churn. For example, a premises parameter may include any information indicative of a status of an insurance policy holder premises and/or a feature of the insurance policy holder premises. Additionally or alternatively, a premises parameter may include information regarding the security of the insurance policy holder premises (e.g., whether the doors and/or windows are locked), safety information (e.g., information regarding whether fire alarm systems, security alarm systems, etc. are operational), information regarding a physical feature of the insurance policy holder premises (e.g., information indicating whether the insurance policy holder premises is on fire, is taking water damage, etc.) and/or any other suitable information.

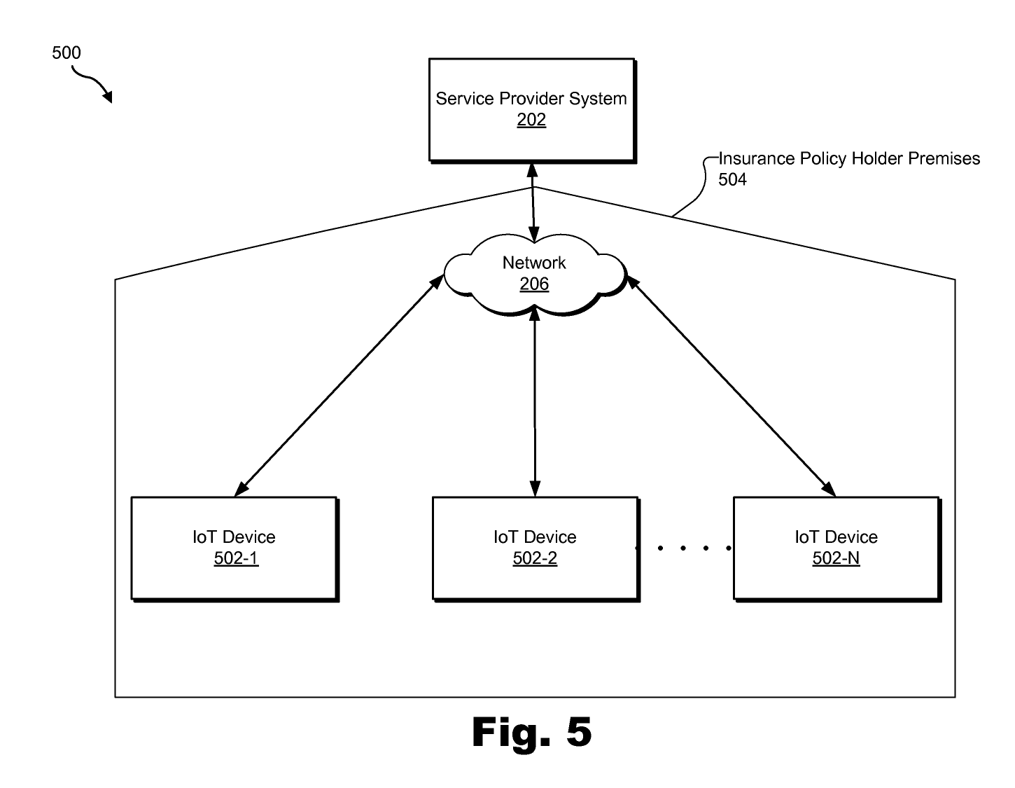

Management facility 102 may access premises parameters as insurance parameter data from one or more IoT devices in any suitable manner. To illustrate, FIG. 5 shows an implementation 500 in which IoT devices 502 (e.g., IoT devices 502-1 through 502-N) are associated with an insurance policy holder premises 504. As shown in FIG. 5, IoT devices 502 communicate with service provider system 202 by way of network 206. Management facility 102 may access the insurance parameter data from IoT devices 502 at any suitable time. For example, management facility 102 may either access the insurance parameter data continually from IoT devices 502 or at predetermined times.

In certain examples, management facility 102 may utilize the premises parameters accessed from IoT devices 502 to facilitate switching insurance carriers that provide insurance policy holder premises insurance coverage to the insurance policy holder. The insurance policy holder premises insurance coverage may include coverage associated with, for example, a homeowner's insurance policy, a renter's insurance policy, a business' insurance policy, and/or any other insurance policy that may be associated with an insurance policy holder. Management facility 102 may utilize the insurance parameter data associated with the premises parameters from IoT devices 502 in any suitable manner.

To illustrate an example, when the insurance policy holder initially registers with the insurance churn service, the insurance policy holder may have insurance policy holder premises insurance coverage provided by an insurance carrier. The insurance policy holder premises insurance coverage may be based on the insurance policy holder being grouped in a first actuarial risk group. IoT devices 502 may monitor premises parameters associated with insurance policy holder premises 504. While IoT devices 502 monitor the premises parameters, the insurance policy holder may perform one or more actions that indicate that the insurance policy holder is now associated with a relatively lower insurance risk. For example, IoT devices 502 may monitor the premises parameters for a predetermined amount of time. During the predetermined amount of time, IoT device 502-1, which may be associated with door locks at insurance policy holder premises 504, may record door lock information indicating that the insurance policy holder consistently locks the doors while the insurance policy holder is away from insurance policy holder premises 504. Additionally, IoT device 502-2, which may be associated with a smoke detector at insurance policy holder premises 504, may record information indicating that batteries in the smoke detector are routinely and timely replaced.

Management facility 102 may access the premises parameters from IoT devices 502-1 and 502-2 at any suitable time and determine that the insurance policy holder is now associated with a relatively lower insurance risk. Based on such a determination, management facility 102 may group the insurance policy holder into a second actuarial risk group and determine that an additional insurance carrier offers an insurance policy holder premises insurance premium that is less than the insurance policy holder premises insurance premium currently paid by the insurance policy holder to the insurance carrier. Management facility 102 may then provide, for display in a graphical user interface on a display screen of a computing device, a price quote associated with the insurance policy holder premises insurance premium together with a graphical object configured to be selected by the insurance policy holder to invoke a one-click switch of insurance policy holder premises insurance coverage. Management facility 102 may detect a selection of the graphical object by the insurance policy holder. Based on the selection, management facility 102 may automatically facilitate switching the insurance policy holder premises insurance coverage from being provided to the insurance policy holder by the insurance carrier to being provided to the insurance policy holder by the additional insurance carrier.

The exemplary implementation 500 shown in FIG. 5 is provided for illustrative purposes only. Although FIG. 5 shows IoT devices 502 being located within insurance policy holder premises 504, it is understood that one or more of IoT devices 502 may be provided outside of insurance policy holder premises 504. In addition, one or more of IoT devices 502 may include mobile computing devices, such as a smart phone, that can move to and from insurance policy holder premises 504 and monitor premises parameters and/or any other suitable insurance parameter data.

To illustrate an example, IoT device 502-2 may be associated with a mobile computing device configured to monitor location information associated with an insurance policy holder while the insurance policy holder is away from insurance policy holder premises 504. Such location information may indicate that the insurance policy holder consistently parks a vehicle more than a particular distance away from insurance policy holder premises 504. The vehicle being parked more than the particular distance away from insurance policy holder premises 504 may subject the insurance policy holder to an increased insurance risk if, for example, the insurance policy holder has to walk through an unsafe area to get to insurance policy holder premises 504 and/or if the vehicle is parked in an unsafe area, on a street, and/or out of sight of the insurance policy holder at the insurance policy holder premises 504. Based on the increased insurance risk, management facility 102 may group the insurance policy holder into another actuarial risk group, which may affect a price quote provided for display by management facility 102 to the insurance policy holder.

In certain examples, IoT devices 502 may monitor health parameters associated with an insurance policy holder. A health parameter may refer to any information that may be used by management facility 102 to provide a health insurance price quote to the insurance policy holder. Management facility 102 may access the health parameters from IoT devices 502 and/or any other suitable data source to facilitate a switch of insurance carriers that provide health insurance coverage to the insurance policy holder. To illustrate, in the example described above, the vehicle being parked more than the particular distance away from insurance policy holder premises 504 may indicate that the insurance policy holder routinely performs a certain amount of exercise due to walking to insurance policy holder premises 504. Over time, such exercise may improve the overall health of the insurance policy holder. Accordingly, management facility 102 may access the location information from IoT device 502-2 to determine a pattern associated with the behavior of the insurance policy holder. Based on the pattern, management facility 102 may group the insurance policy holder in an actuarial risk group associated with a relatively lower level of health insurance risk. Based on the actuarial risk group, management facility 102 may provide an insurance price quote to the insurance policy holder to facilitate a switch of insurance carriers that provide health insurance coverage to the insurance policy holder.

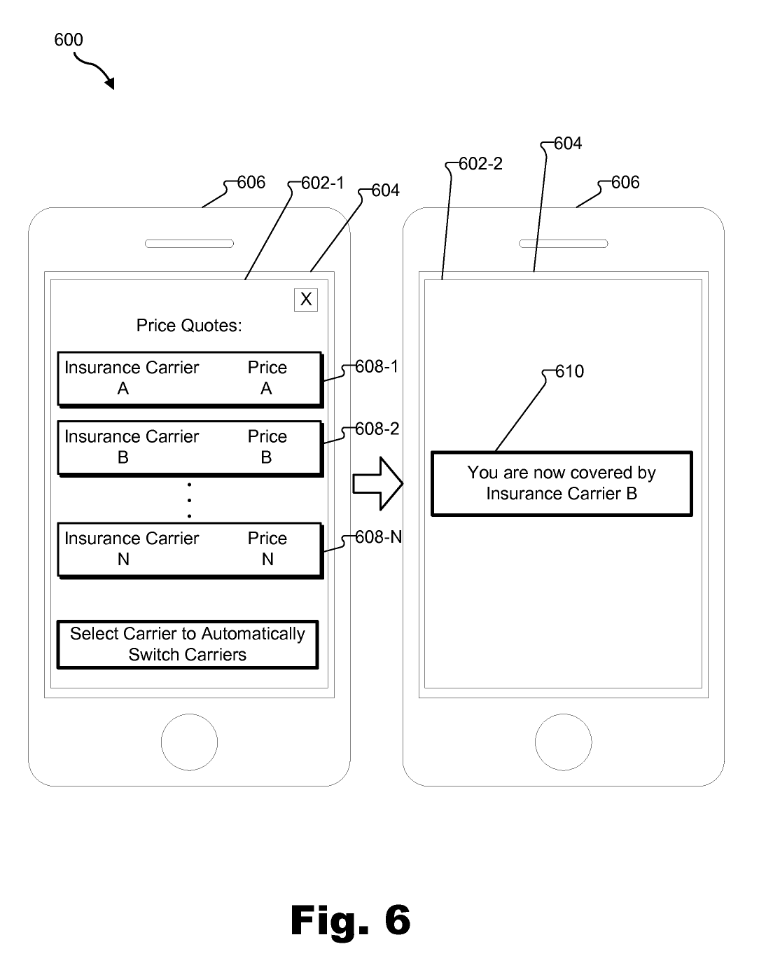

As mentioned, to facilitate insurance churn, management facility 102 may provide one or more graphical user interfaces for display on a display screen of a computing device. Management facility 102 may provide the graphical user interfaces for display in any suitable manner and at any suitable time. For example, management facility 102 may provide a graphical user interface for display to an insurance policy holder after management facility 102 determines that there are one or more price quotes that may be provided for display to the insurance policy holder. To illustrate, FIG. 6 shows an exemplary implementation 600 in which graphical user interfaces 602 (e.g., graphical user interfaces 602-1 and 602-2) are provided for display on a display screen 604 of a mobile computing device 606. As shown in FIG. 6, graphical user interface 602-1 may include a plurality of price quotes provided with a plurality of graphical objects 608 (e.g., graphical objects 608-1 through 608-N). Each graphical object 608 may include information indicating the price quote and an insurance carrier associated with the price quote. For example, graphical object 608-1 includes information indicating that price quote A is provided by insurance carrier A, price quote B is provided by insurance carrier B, and price quote N is provided my insurance carrier N. Graphical objects 608 and/or graphical user interface 602-1 may include any other suitable information in other implementations. For example, as shown in FIG. 6, graphical user interface 602-1 may also include a notification informing the insurance policy holder that a selection of one of the graphical objects 608 will automatically switch insurance carriers.

Management facility 102 may detect a selection of one of graphical objects 608 in any suitable manner. For example, management facility 102 may detect a touch input by the insurance policy holder on graphical object 608-2. Based on the selection of one of graphical object 608-2, management facility 102 may provide graphical user interface 602-2 for display on display screen 604. As shown in FIG. 6, graphical user interface 602-2 includes a notification 610 informing the insurance policy holder that the insurance policy holder now has insurance coverage provided by insurance carrier B. In certain examples, the insurance coverage may change to being provided by insurance carrier B immediately upon selection of graphical object 608-2. In such an example, management facility 102 may provide notification 610 for display on display screen 604. Alternatively, the insurance coverage provided by insurance carrier B may begin a predetermined amount of time after the selection of graphical object 608-2 by the insurance policy holder. In such an example, management facility 102 may provide for display on display screen 602-2 a notification indicating that the insurance coverage provided by insurance carrier B will begin at a particular time. In certain examples, the particular time may coincide with a time when the previous insurance coverage of the insurance policy holder is set to expire such that there is no gap in insurance coverage.

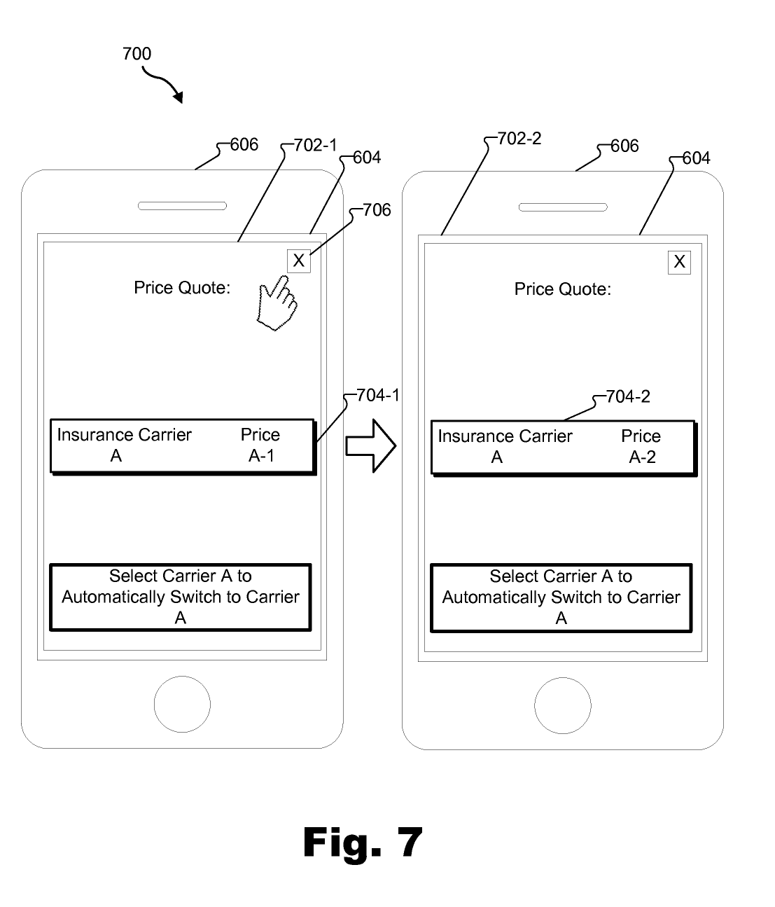

In certain examples, management facility 102 may detect that a price quote provided for display on display screen 604 is not acceptable to the insurance policy holder. Management facility 102 may detect that the price quote is not acceptable in any suitable manner. For example, management facility 102 may detect a user input provided by the insurance policy holder that closes or minimizes a graphical user interface that provides a price quote. To illustrate, FIG. 7 shows an exemplary implementation 700 in which graphical user interfaces 702 (e.g., graphical user interfaces 702-1 and 702-2) are provided for display on display screen 604. As shown in FIG. 7, graphical user interfaces 702 may include price quotes (e.g., price quotes A1 and A2) provided for display with graphical objects 704 (e.g., graphical objects 704-1 and 704-2). Management facility 102 may detect a user input associated with a graphical object 706 that indicates that the insurance policy holder does not accept a price quote A-1 provided together with graphical object 704-1. Based on the user input associated with graphical object 706, management facility 102 may solicit and receive an updated price quote A-2 from insurance carrier A. After receiving the updated price quote A-2, management facility 102 may provide for display the updated price quote A-2 for display in graphical user interface 702-2 together with graphical object 704-2 instead of price quote A1. Updated price quote A-2 may be lower in price than price quote A-1 and/or may provide some other benefit that may be useful to persuade the insurance policy holder to switch to having insurance coverage provided by insurance carrier A.

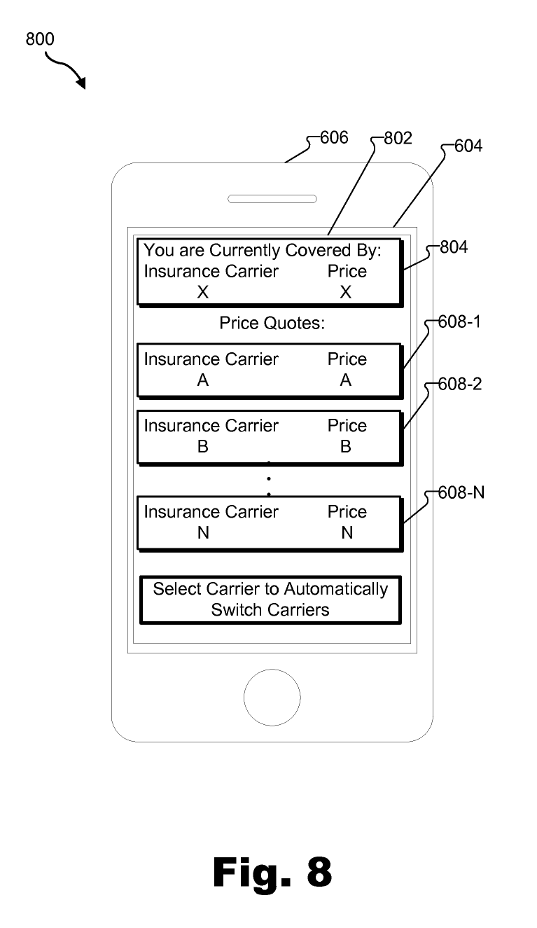

In certain examples, management facility 102 may provide, for display together with one or more price quotes, a notification indicating which insurance carrier currently provides insurance coverage to the insurance policy holder and/or a price associated with that insurance coverage. To illustrate, FIG. 8 shows an exemplary implementation 800 in which a graphical user interface 802 is provided for display on display screen 604. In the example shown in FIG. 8, a notification 804 is provided for display together with graphical objects 608. As shown in FIG. 8, notification 804 indicates that the insurance policy holder currently has insurance coverage through insurance carrier X and that a price X is associated with that insurance coverage. Through notification 804, the insurance policy holder is able to readily compare current insurance policy information with information included with graphical objects 608 to determine whether to switch insurance carriers.

In certain examples, management facility 102 may provide a notification to the insurance policy holder indicating when the insurance policy holder qualifies for a lower-priced insurance premium. Management facility 102 may provide such a notification in any suitable manner and at any suitable time. For example, management facility 102 may access insurance parameter data from one or more data sources (e.g., data sources 204) and determine that the insurance policy holder now qualifies to be grouped in a different actuarial risk group, which may be associated with a lower-priced insurance premium. Accordingly, management facility 102 may provide a notification to the insurance policy holder based on the determination. In certain examples, such a notification may also inquire whether the insurance policy holder wants to receive a price quote. The insurance policy holder may enter any suitable user input associated with the notification and subsequently be presented with one or more price quotes in any suitable manner, such as described herein.

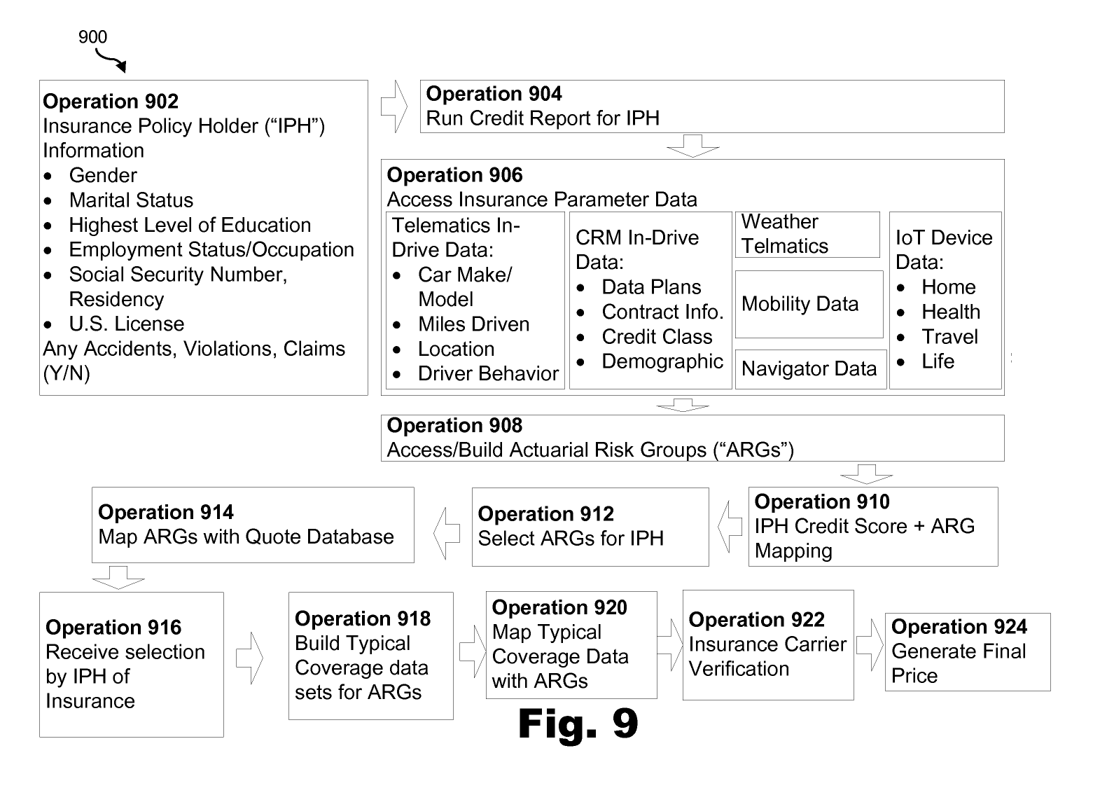

FIG. 9 illustrates an exemplary flow diagram 900 showing various operations that may be performed by management facility 102. In operation 902, management facility 102 may receive insurance policy holder information from an insurance policy holder. Management facility 102, may receive the insurance policy holder information as preliminary insurance parameter data during, for example, a registration process, such as described herein. As shown in FIG. 9, the insurance policy holder information may include information regarding a gender, a marital status, a highest level of education, an employment status/occupation, a social security number, a residency status, and/or license information (e.g., information regarding accidents, violations, claims, etc.) of the insurance policy holder. Management facility 102 may access and/or receive other insurance policy holder information in other implementations.

In operation 904, management facility 102 may run a credit report to check a credit history of the insurance policy holder. Management facility 102 may run the credit report in any suitable manner. For example, management facility 102 may request and receive the credit report from any one or a number of credit reporting agencies.

In operation 906, management facility 102 may access insurance parameter data associated with the insurance policy holder. Management facility 102 may access the insurance parameter data from any suitable data source (e.g., data sources 204) in any suitable manner, such as described herein. As shown in FIG. 9, the insurance parameter data may include telematics in-drive data (car make/model, miles driven, location, driver behavior, etc.), customer relationship management (“CRM”) in-drive data (data plans, contract information, credit class information, demographic information), weather telematics data, mobility data, navigator data, and/or IoT device data (e.g., from IoT devices configured to monitor data associated with home insurance, health insurance, travel insurance, life insurance, etc.). Management facility 102 may access the insurance parameter data from the data sources by way of a real time streaming system, by batch processing, and/or in any other suitable manner.

In operation 908, management facility 102 may access and/or build actuarial risk groups based on the information obtained in one or more of operations 902-906. In examples where management facility accesses actuarial risk groups, management facility 102 may access the actuarial risk groups from one or more insurance carriers and/or one or more third parties. To access the actuarial risk groups, management facility 102 may interface with one or more application programing interfaces associated with the one or more insurance carriers and/or the one or more third parties. In examples where management facility 102 builds the actuarial risk groups, management facility 102 may transform the insurance parameter data into a table with, for example, rows corresponding to insurance policy holders and columns corresponding to attributes that are derived by management facility 102 based on the accessed insurance parameter data. Each attribute included in the table may be indicative of a subset of insurance policy holders. Management facility may transform certain insurance parameter data such as that received from telematics devices (e.g., telematics device 402) into attributes such as minimum velocity, median velocity, average velocity, maximum velocity, acceleration, braking speed, driving distance, dwell time, etc. Management facility 102 may also include point of interest information in the table. Such point of interest information may include, for example, information indicating a residence location, information indicating a work location, etc. After management facility 102 generates the table, management facility 102 may cluster the data in the table using an algorithm such as k-means. The clusters may be grouped according to credit score and/or related risk measures. Management facility may predict individual risk scores associated with individual insurance policy holders and build actuarial risk groups by utilizing any suitable data processing method such as by using an 11-regularized regression algorithm, decision trees, neural networks, and/or other related methods. Management facility 102 may build actuarial risk groups in other suitable ways in other implementations.

In operation 910, management facility 102 may map the credit report(s) obtained in operation 904 to the actuarial risk groups accessed/built in operation 908.

In operation 912, management facility 102 may select an actuarial risk group for the insurance policy holder. The selection of the actuarial risk group may be based on any one or a combination of the information accessed, received, and/or generated in operations 902-910.

In operation 914, management facility 102 may map the actuarial risk group with a quote database that includes insurance policy price quote information. In certain examples, management facility 102 may access a quote database provided by one or more insurance carriers. When management facility 102 accesses the quote database, management facility 102 may interface with one or more application programing interfaces provided by the one or more insurance carriers.

In operation 916, management facility 102 may receive a selection by the insurance policy holder of insurance from an insurance carrier based on operation 914. Management facility 102 may receive the selection in any suitable manner, such as described herein.

In operation 918, management facility 102 may build typical coverage data sets for the actuarial risk groups. The typical coverage data sets may include information regarding what limits, deductibles, coverages, etc. are typically associated with a particular actuarial risk group.

In operation 920, management facility 102 may map the typical coverage data sets built in operation 918 with the actuarial risk groups.

In operation 922, management facility 102 may receive verification from the insurance carrier regarding the mapping of the actuarial risk groups with the quote database and/or the typical coverage data sets. For example, the insurance carrier may guarantee to provide insurance coverage at a particular price based on the insurance policy holder being grouped in a particular actuarial risk group.

In operation 924, management facility 102 may generate a final price associated with the insurance provided by the insurance carrier. Management facility 102 may provide a notification of the final price to the insurance policy holder in any suitable manner.

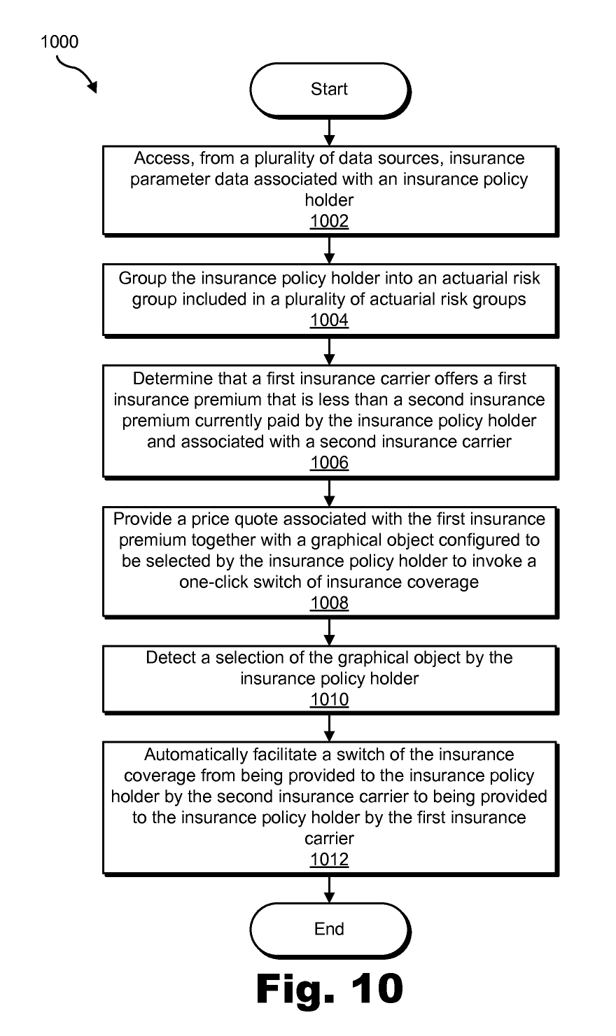

FIG. 10 illustrates an exemplary insurance churn method 1000 according to principles described herein. While FIG. 10 illustrates exemplary operations according to certain embodiments, other embodiments may omit, add to, reorder, combine, and/or modify any of the operations shown in FIG. 10. In certain embodiments, one or more of the operations shown in FIG. 10 may be performed by system 100 and/or one or more components or implementations of system 100.

In operation 1002, a system (e.g., system 100) may access insurance parameter data associated with an insurance policy holder from a plurality of data sources. As described herein, in certain examples, the plurality of data sources include a tracking device associated with the insurance policy holder. Operation 1002 may be performed in any of the ways described herein.

In operation 1004, the system may group the insurance policy holder into an actuarial risk group included in a plurality of actuarial risk groups. As described herein, the system may group the insurance policy holder into the actuarial risk group based on the insurance parameter data. Operation 1004 may be performed in any of the ways described herein.

In operation 1006, the system may determine that a first insurance carrier offers a first insurance premium that is less than a second insurance premium currently paid by the insurance policy holder and associated with a second insurance carrier. Operation 1006 may be performed in any of the ways described herein.

In operation 1008, the system may provide a price quote associated with the first insurance premium together with a graphical object configured to be selected by the insurance policy holder to invoke a one-click switch of insurance coverage from being provided to the insurance policy holder by the second insurance carrier to being provided to the insurance policy holder by the first insurance carrier. As described herein, the insurance coverage may include vehicular insurance coverage and/or any other type of insurance coverage that may be associated with the insurance policy holder. Operation 1008 may be performed in any of the ways described herein.

In operation 1010, the system may detect a selection of the graphical object by the insurance policy holder. Operation 1010 may be performed in any of the ways described herein.

In operation 1012, the system may automatically facilitate a switch of the insurance coverage from being provided to the insurance policy holder by the second insurance carrier to being provided to the insurance policy holder by the first insurance carrier. Operation 1012 may be performed in any of the ways described herein.

In certain examples, any of the exemplary insurance churn systems and methods described herein may use a telematics based representation of driving behavior. For example, management facility 102 may access insurance parameter data in the form of a telematics based representation of driving behavior from a source and use the telematics based representation of the driving behavior, alone or together with other forms of insurance parameter data, to assess driver risk and group an insurance policy holder into an actuarial risk group as described herein. This use of a telematics based representation of driving behavior is illustrative only. A telematics based representation of driving behavior may be used in additional or alternative ways in other examples. Examples of telematics based systems and methods for determining and representing driving behavior, as well as examples of applications of a telematics based representation of driving behavior, will now be described.

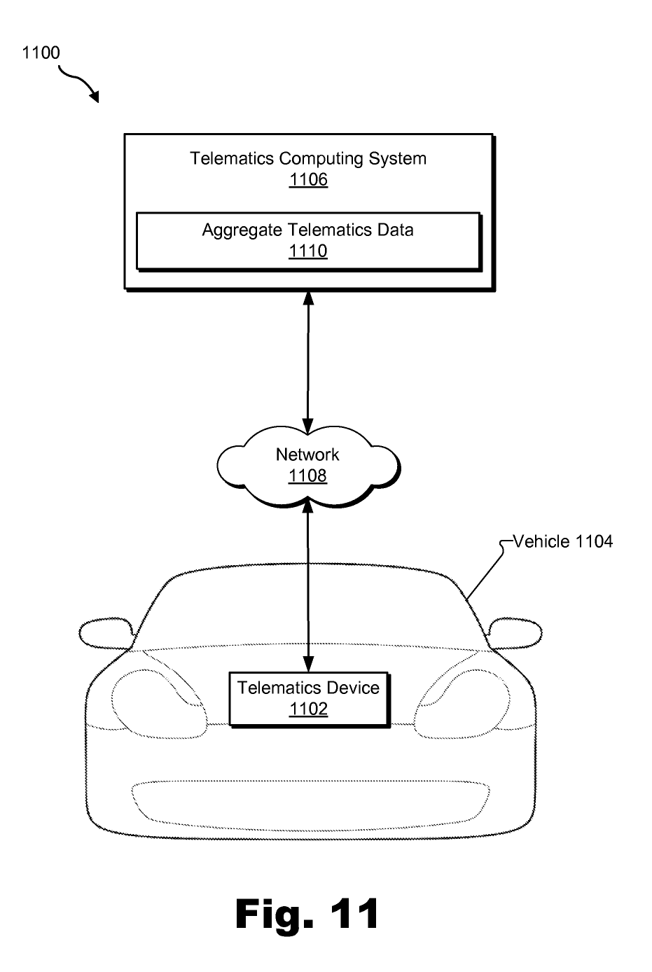

FIG. 11 illustrates an exemplary telematics system 1100 (“system 1100”). As shown, system 1100 may include a telematics device 1102 associated with a vehicle 1104. The telematics device 1102 may be associated with the vehicle 1104 in any way that enables the telematics device 1102 to monitor one or more operational parameters of the vehicle 1104. Telematics device 1102 may include any of the exemplary telematics devices described herein and/or may perform any of the exemplary telematics device operations described herein.

Telematics device 1102 may be communicatively coupled to a telematics computing system 1106 by way of a network 1108 such that telematics device 1102 may transmit data (e.g., telematics data acquired or generated by the telematics device 1102) to the telematics computing system 1106. Telematics device 1102 and telematics computing system 1106 may communicate by way of network 1108 using any suitable communication technologies, including any of the exemplary communication technologies disclosed herein. Network 1108 may include any suitable network or combination of networks, such as any of those disclosed herein.

Telematics computing system 1106 may include one or more computing devices, such as one or more server computing devices configured to perform one or more of the exemplary operations of telematics computing system 1106 described herein. Telematics computing system 1106 may be operated by a service provider, such as a telematics service provider.

Telematics computing system 1106 may collect telematics data from telematics device 1102 in any suitable way, such as by continually or periodically receiving telematics data from telematics device 1102 by way of network 1108. The telematics data may include data representative of any parameters of telematics device 1102 and/or vehicle 1104 that are monitored by telematics device 1102. For example, the telematics data may indicate information about operation of vehicle 1104 (e.g., information about acceleration, revolutions per minute (RPMs), braking, speed, location, time of operations, date of operations, etc. of vehicle 1104).

Telematics computing system 1106 may aggregate the telematics data collected over time from telematics device 1102. Telematics computing system 1106 may perform the aggregation in any suitable way, such as by maintaining aggregate telematics data for a rolling period of time (e.g., a rolling year of telematics data). Such data may be maintained by telematics computing system 1106 as aggregate telematics data 1110, as shown in FIG. 11.

Telematics computing system 1106 may analyze the aggregated telematics data to determine a set of discrete segments of driving behavior associated with the vehicle. As used herein, a discrete segment of driving behavior includes a time-based and/or a geographic-based segment of driving behavior associated with a particular pattern of driving behavior. Such a discrete segment is separate from other time-based and/or geographic-based segments of driving behavior associate with different patterns of driving behavior.

To illustrate one example, a driver may have a recurring pattern of driving behavior in which the driver drives vehicle 1104 to and from work on weekdays and another recurring pattern of behavior in which the driver exhibits suburban errand-running driving behavior on weekends. Telematics computing system 1106 may analyze aggregate telematics data to determine a first discrete segment of driving behavior that includes the driver driving vehicle 1104 to and from a workplace on weekdays and a second, separate discrete segment of driving behavior that includes the driver driving vehicle 1104 to and from errands nearby his residence on weekends.

To illustrate another example, a driver may have a recurring pattern of driving behavior in which the driver drives vehicle 1104 to and from work on Mondays, Wednesdays, and Fridays and another recurring behavior in which the driver works from home on Tuesdays and Thursdays. Telematics computing system 1106 may analyze aggregate telematics data to determine a first discrete segment of driving behavior that includes the driver driving vehicle 1104 to and from work a workplace on Mondays, Wednesdays, and Fridays and a second, separate discrete segment of driving behavior that includes the driver working from home on Tuesdays and Thursdays.

Telematics computing system 1106 may analyze the aggregate telematics data in any suitable way to identify one or more sets of driving behavior. For example, telematics computing system 1106 may search the aggregate telematics data for identifiable changes in patterns of driving behavior. For example, telematics computing system 1106 may identify, from the aggregate telematics data, a pattern of vehicle 1104 being driven to and from work changes to a different driving pattern. After identifying such a change in driving behavior, telematics computing system 1106 may search the aggregate telematics data to identify patterns that correspond to specific driving patterns. For example, telematics computing system 1106 may identify, from the aggregate telematics data, a first recurring pattern of driving behavior in which vehicle 1104 is driven to and from a workplace on certain days of the week and a second recurring pattern of driving behavior in which vehicle 1104 is not driven to and from a workplace on certain other days of the week.

Telematics computing system 1106 may use the identified recurring patterns of driving behavior to define a set of discrete segments of driving behavior associated with vehicle 1104. For example, telematics computing system 1106 may define a first discrete segment of driving behavior to represent a first recurring pattern of driving behavior and a second discrete segment of driving behavior to represent a second recurring pattern of driving behavior.

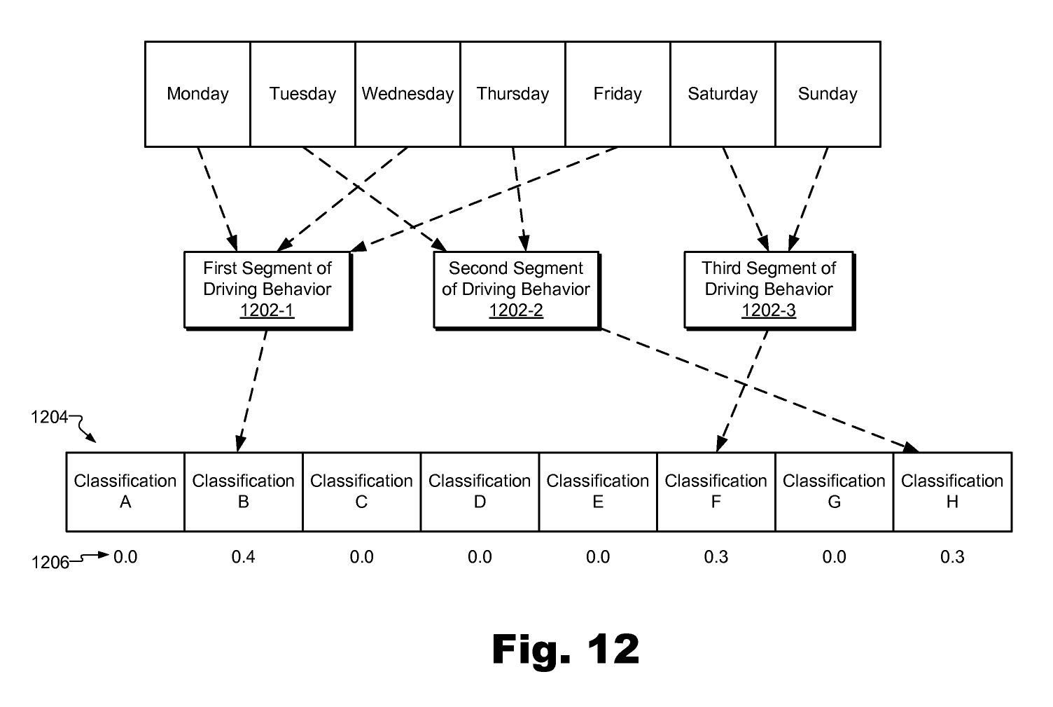

FIG. 12 illustrates an exemplary set of discrete segments 1202 of driving behavior. As show, the set of discrete segments 1202 of driving behavior may include a first discrete segment 1202-1, a second discrete segment 1202-2, and a third discrete segment 1202-3 of driving behavior. In one example, the first discrete segment 1202-1 may represent driving behavior in which vehicle 1104 is driven to and from a workplace on Monday, Wednesday, and Friday, the second discrete segment 1202-2 may represent driving behavior in which vehicle 1104 remains at a residence (e.g., while the owner of the vehicle telecommutes from home) on Tuesday and Thursday, and the third discrete segment 1202-3 may represent driving behavior in which vehicle 1104 is driven to and from locations nearby a residence associated with vehicle 1104 (e.g., when the owner of the vehicle runs errands) on Saturday and Sunday. These associations between the days of the week and the discrete segments 1202 of driving behavior are represented by dashed lines interconnecting the days of the week and the discrete segments 1202 of driving behavior.

Telematics computing system 1106 may classify the set of discrete segments 1202 of driving behavior associated with vehicle 1104 based on the analysis of the aggregated telematics data. In certain examples, telematics computing system 1106 may classify the discrete segments 1202 within an array of available classifications of driving behavior by determining a best fit classification for each discrete segment 1202 of driving behavior associated with vehicle 1104. For instance, an array of available classifications of driving behavior may include all predefined classifications of driving behavior, and telematics computing system 1106 may select a particular predefined classification of driving behavior from the predefined array of classifications of driving behavior that is a best fit for a particular discrete segment 1202 of driving behavior associated with vehicle 1104.

FIG. 12 illustrates an exemplary array of predefined classifications 1204 (e.g., classification A-classification H). Each predefined classification 1204 may define a different set of driving behavior parameters. For example, predefined classification A may define a set of driving behavior parameters indicative of on-the-job driving behavior (e.g., when a vehicle is used for work), predefined classification B may define a set of driving behavior parameters indicative of commuter driving behavior, and so on. In certain examples, available classifications included in the array of predefined classifications 1204 may be ordered from greatest risk to least risk.

Telematics computing system 1106 may determine a best fit classification for a discrete segment 1202 of driving behavior in any suitable way. For example, telematics computing system 1106 may compare driving behavior parameters of the discrete segment 1202 of driving behavior to sets of driving behavior parameters defined by the predefined classifications 1204 and identify the closest match based on the comarisons. When the closest match is found, telematics computing system 1106 may classify the discrete segment 1202 of driving behavior to be the identified best fit predefined classification. In FIG. 12, dashed lines interconnecting the discrete segments 1202 of driving behavior and the array of predefined classifications 1204 represent assignments of the discrete segments 1202 of driving behavior to particular classifications within the array of predefined classifications. For example, the first discrete segment 1202-1 of driving behavior is classified as classification B, the second discrete segment 1202-2 of driving behavior is classified as classification H, and the third discrete segment 1202-3 of driving behavior is classified as classification F.

Telematics computing system 1106 may generate a representation of the driving behavior associated with vehicle 1104 based on the classification of the set of discrete segments 1202 of the driving behavior to specific predefined classifications. Telematics computing system 1106 may generate the representation in any suitable form, such as with any suitable data structure or group of data structures.

In certain examples, the representation of the driving behavior associated with vehicle 1104 may include data representative of the array of all available predefined classifications 1204 and weighting factors assigned to the predefined classifications included in the array. For example, FIG. 12 illustrates a set of weighting factors 1206 assigned to the predefined classifications included in the array of predefined classifications 1204.

The generation of the representation of the driving behavior associated with vehicle 1104 by telematics computing system 1106 may include telematics computing system 1106 generating and assigning the weighting factors 1206 to the predefined classifications included in the array of predefined classifications 1204. Telematics computing system 1106 may generate and assign the weighting factors in any suitable way based at least in part on the classification of the set of discrete segments 1202 of driving behavior to certain predefined classifications. For example, telematics computing system 1106 may assign non-zero value weighting factors to any classification to which a discrete segment 1202 is classified. Other classifications not selected for any discrete segment 1202 may be assigned zero value weighting factors. FIG. 12 illustrates an example in which non-zero value weighting factors have been assigned to classifications A, H, and F based on the respective classification of first, second, and third discrete segments 1202 to classifications A, H, and F.

Telematics computing system 1106 may generate a particular non-zero value weighting factor to assign to a particular classification based on any suitable weighting criteria. For example, telematics computing system 1106 may generate non-zero value weighting factors based on a distribution of driving behavior across discrete segments 1202 and/or classifications of driving behavior. Such weighting factors may represent ratios between classified segments of driving behavior, such as ratios of total driving time and/or days attributed to each classified segment of driving behavior compared to other classified segments of driving behavior. In FIG. 12, for example, telematics computing system 1106 has assigned weighting factor values that represent ratios of specific patterns of driving behavior to total driving days. Specifically, classification B is assigned a 0.4 weighting factor value to represent that three out of seven days of a week are associated with the discrete segment 1202-1 classified as classification B, classification H is assigned a 0.3 weighting factor value to represent that two out of seven days of a week are associated with the discrete segment 1202-2 classified as classification H, and classification F is assigned a 0.3 weighting factor value to represent that two out of seven days of a week are associated with the discrete segment 1202-3 classified as classification F. In certain examples, a sum total of the set of weighting factors for classifications of driving behavior for a vehicle may be equal to a value of one.

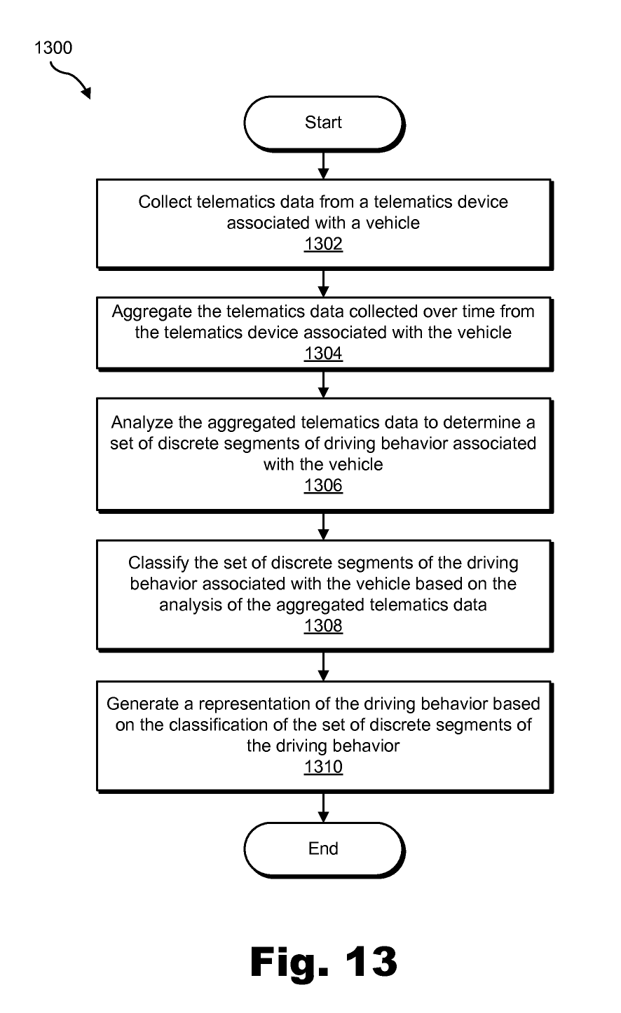

FIG. 13 illustrates an exemplary telematics based method 1300 of determining and representing driving behavior. While FIG. 13 illustrates exemplary operations according to certain embodiments, other embodiments may omit, add to, reorder, combine, and/or modify any of the operations shown in FIG. 13. In certain embodiments, one or more of the operations shown in FIG. 13 may be performed by system 100, system 1100, and/or one or more components or implementations of system 100 and/or system 1100.

In operation 1302, a system (e.g., telematics computing system 1106) collects telematics data from a telematics device associated with a vehicle, such as described herein.

In operation 1304, the system aggregates the telematics data collected over time from the telematics device associated with the vehicle, such as described herein.

In operation 1306, the system analyzes the aggregated telematics data to determine a set of discrete segments of driving behavior associated with the vehicle. Operation 1306 may be performed in any of the ways described herein.

In operation 1308, the system classifies the set of discrete segments of the driving behavior associated with the vehicle based on the analysis of the aggregated telematics data. Operation 1308 may be performed in any of the ways described herein.

In operation 1310, the system generates a representation of the driving behavior based on the classification of the set of discrete segments of the driving behavior. Operation 1308 may be performed in any of the ways described herein. In certain examples, the generated representation of the driving behavior may include data representative of an array of predefined classifications and weighting factors assigned to the predefined classifications included in the array in any of the ways described herein.

By generating a representation of driving behavior to include weighting factors assigned to classifications of discrete segments of driving behavior as described herein, a system such as telematics computing system 1106 may generate a complex driving behavior profile that accurately represents driving behavior associated with a vehicle at a granular level. Such telematics-based, granular, and weighted representations of driving behavior may be used for new and/or improved applications of driving behavior data.

To illustrate, in certain examples, telematics computing system 1106 may use such representations of driving behavior to determine risk associated with the vehicle. Telematics computing system 1106 may determine a risk score for the vehicle based on such representations of driving behavior alone or in combination with additional risk factors such as geographic location of the vehicle (e.g., where the vehicle is parked), a geographic location of a residence of a driver of the vehicle, a credit score for the driver of the vehicle, an insurance history for the driver of the vehicle (e.g., a history of insurance claims, driving related citations, automobile accidents, etc.), and/or any other suitable risk factors.

Telematics computing system 1106 may output the determined risk score for use in further determining risk and/or determining insurance rates for the determined risk. In certain embodiments, for example, telematics computing system 1106 may provide a determined risk score to system 100 for use (e.g., as insurance parameter data) in grouping an insurance policy holder into an actuarial risk group included in a plurality of actuarial risk groups. System 100 may then generate and/or obtain insurance premium quotes based on the actuarial risk group and provide such quotes to an insurance policy holder, such as described herein.

In certain embodiments, one or more of the components and/or processes described herein may be implemented and/or performed by one or more appropriately configured computing devices. To this end, one or more of the systems and/or components described above may include or be implemented as one or more computing systems and/or components by any computer hardware, computer-implemented instructions (e.g., software) embodied in a non-transitory computer-readable medium, or combinations of computer-implemented instructions and hardware, configured to execute one or more of the processes described herein. In particular, system components may be implemented on one physical computing device or may be implemented on more than one physical computing device. Accordingly, system components may include any number of physical computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (DRAM), which typically constitutes a main memory. Common forms of computer-readable media include, for example, a floppy disk, flexible disk, hard disk, magnetic tape, any other magnetic medium, a Compact Disc Read-Only Memory (CD-ROM), DVD, any other optical medium, a Random-Access Memory (RAM), a Programmable ROM (PROM), an Erasable PROM (EPROM), a Flash Electrically EPROM (FLASH-EEPROM), any other memory chip or cartridge, or any other tangible medium from which a computer may read.

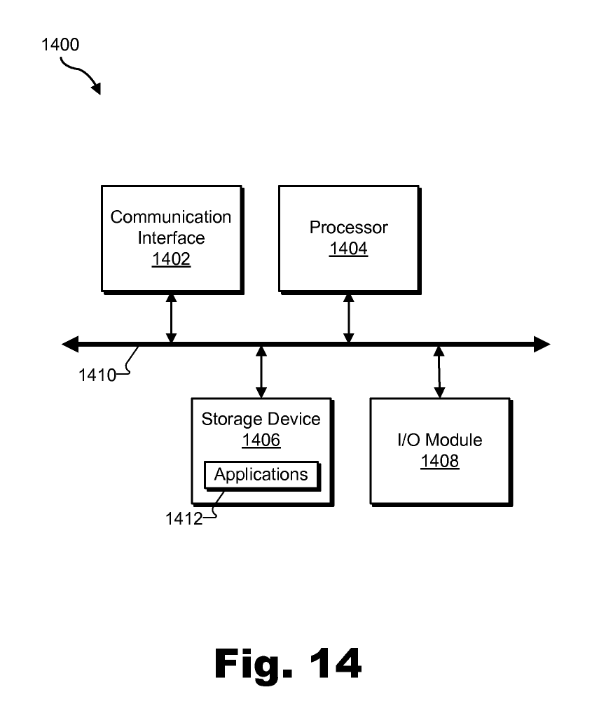

FIG. 14 illustrates an exemplary computing device 1400 that may be configured to perform one or more of the processes described herein. As shown in FIG. 14, computing device 1400 may include a communication interface 1402, a processor 1404, a storage device 1406, and an input/output (I/O) module 1408 communicatively connected via a communication infrastructure 1410. While an exemplary computing device 1400 is shown in FIG. 14, the components illustrated in FIG. 14 are not intended to be limiting. Additional or alternative components and/or configurations of components may be used in other embodiments. For example, in addition or alternative to being communicatively connected by way of communication infrastructure 1410, one or more components of computing device 1400 may be communicatively connected by way of one or more other suitable interfaces. For instance, communication interface 1402, storage device 1406, I/O module 1408, and/or any other components of computing device 1400 may be communicatively coupled directly to processor 1404 via one or more interfaces (e.g., discrete interfaces). Components of computing device 1400 shown in FIG. 14 will now be described in additional detail.

Communication interface 1402 may be configured to communicate with one or more computing devices. Examples of communication interface 1402 include, without limitation, a wired network interface (such as a network interface card), a wireless network interface (such as a wireless network interface card), a modem, and any other suitable interface. In at least one embodiment, communication interface 1402 may provide a direct connection between system 100 and one or more of provisioning systems via a direct link to a network, such as the Internet. Communication interface 1402 may additionally or alternatively provide such a connection through, for example, a local area network (such as an Ethernet network), a personal area network, a telephone or cable network, a satellite data connection, a dedicated URL, or any other suitable connection. Communication interface 1402 may be configured to interface with any suitable communication media, protocols, and formats, including any of those mentioned above.

Processor 1404 generally represents any type or form of processing unit capable of processing data or interpreting, executing, and/or directing execution of one or more of the instructions, processes, and/or operations described herein. Processor 1404 may direct execution of operations in accordance with one or more applications 1412 or other computer-executable instructions such as may be stored in storage device 1406 or another computer-readable medium.

Storage device 1406 may include one or more data storage media, devices, or configurations and may employ any type, form, and combination of data storage media and/or device. For example, storage device 1406 may include, but is not limited to, a hard drive, network drive, flash drive, magnetic disc, optical disc, random access memory (RAM), dynamic RAM (DRAM), other non-volatile and/or volatile data storage units, or a combination or sub-combination thereof. Electronic data, including data described herein, may be temporarily and/or permanently stored in storage device 1406. For example, data representative of one or more executable applications 1412 (which may include, but are not limited to, one or more of the software applications described herein) configured to direct processor 1404 to perform any of the operations described herein may be stored within storage device 1406. In some examples, data may be arranged in one or more databases residing within storage device 1406.

I/O module 1408 may be configured to receive user input and provide user output and may include any hardware, firmware, software, or combination thereof supportive of input and output capabilities. For example, I/O module 1408 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1408 may include one or more devices for presenting output to a user, including, but not limited to, a graphics engine, a display (e.g., a touch screen, one or more output drivers (e.g., display drivers), one or more audio speakers, and one or more audio drivers. In certain embodiments, I/O module 1408 is configured to provide graphical data to a display for presentation to a user. The graphical data may be representative of one or more graphical user interfaces and/or any other graphical content as may serve a particular implementation.

In some examples, any of the systems and/or facilities described herein may be implemented by or within one or more components of computing device 1400. For example, one or more applications 1412 residing within storage device 1406 may be configured to direct processor 1404 to perform one or more processes or functions associated with system 100, system 1100, or any components thereof.

To the extent the aforementioned embodiments collect, store, and/or employ personal information provided by individuals (or other entities), it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
collecting, by a telematics computing system, telematics data from a telematics device associated with a vehicle;
aggregating, by the telematics computing system, the telematics data collected over time from the telematics device associated with the vehicle;
analyzing, by the telematics computing system, the aggregated telematics data to determine a set of discrete segments of driving behavior associated with the vehicle;
classifying, by the telematics computing system, the set of discrete segments of the driving behavior associated with the vehicle based on the analyzing of the aggregated telematics data; and
generating, by the telematics computing system, a representation of the driving behavior based on the classifying of the set of discrete segments of the driving behavior, the generated representation of the driving behavior including weighting factors assigned to the classified set of discrete segments of the driving behavior.

2. The method of claim 1, wherein the classifying of the set of discrete segments of the driving behavior associated with the vehicle comprises:
selecting predefined classifications of driving behavior from an array of predefined classifications of driving behavior; and
assigning the set of discrete segments of the driving behavior associated with the vehicle to the selected predefined classifications.

3. The method of claim 2, wherein the generated representation of the driving behavior includes data representative of the array of predefined classifications of driving behavior.

4. The method of claim 3, wherein:
the weighting factors assigned to the classified set of discrete segments of the driving behavior comprise non-zero value weighting factors assigned to the selected predefined classifications of driving behavior to which the set of discrete segments of the driving behavior associated with the vehicle are assigned; and
the generated representation of the driving behavior further includes data representative of zero value weighting factors assigned to other predefined classifications of driving behavior included in the array of predefined classifications of driving behavior and to which the set of discrete segments of the driving behavior associated with the vehicle are not assigned.

5. The method of claim 1, wherein the weighting factors assigned to the classified set of discrete segments of the driving behavior represent ratios between the discrete segments included in the classified set of discrete segments of the driving behavior.

6. The method of claim 1, wherein the telematics device includes a dedicated telematics device that is communicatively coupled to an operating system of the vehicle.

7. The method of claim 1, wherein the telematics device includes a mobile communications device associated with the insurance policy holder.

8. The method of claim 1, further comprising:
determining a risk score for the vehicle based at least in part on the generated representation of the driving behavior;
grouping an insurance policy holder associated with the vehicle into an actuarial risk group included in a plurality of actuarial risk groups;
determining, based on the actuarial risk group, that a first insurance carrier offers a first insurance premium that is less than a second insurance premium currently paid by the insurance policy holder and associated with a second insurance carrier;
providing, by an insurance churn management system for display in a graphical user interface on a display screen of a computing device, a price quote associated with the first insurance premium together with a graphical object configured to be selected by the insurance policy holder to invoke a one-click switch of insurance coverage from being provided to the insurance policy holder by the second insurance carrier to being provided to the insurance policy holder by the first insurance carrier;
detecting, by the insurance churn management system, a selection of the graphical object by the insurance policy holder; and
automatically facilitating switching, by the insurance churn management system based on the detected selection of the graphical object, the insurance coverage from being provided to the insurance policy holder by the second insurance carrier to being provided to the insurance policy holder by the first insurance carrier.

9. The method of claim 1, further comprising providing, by the insurance churn management system for display in the graphical user interface, a notification of the second insurance premium currently paid by the insurance policy holder and associated with the second insurance carrier.

10. The method of claim 1, further comprising providing, by the insurance churn management system for display in the graphical user interface and in response to the automatically facilitating switching of the insurance coverage, a notification that the insurance policy holder has an insurance policy with the first insurance carrier.

11. The method of claim 1, embodied as computer-executable instructions on at least one non-transitory computer-readable medium.

12. A method comprising:
collecting, by a telematics computing system comprising at least one physical computing device, telematics data from a telematics device associated with a vehicle;
aggregating, by the telematics computing system, the telematics data collected over time from the telematics device associated with the vehicle;
analyzing, by the telematics computing system, the aggregated telematics data to determine a first discrete segment of driving behavior associated with the vehicle and a second discrete segment of driving behavior associated with the vehicle;
classifying, by the telematics computing system based on the analyzing of the aggregated telematics data, the first discrete segment of the driving behavior associated with the vehicle by selecting a first predefined classification of driving behavior from an array of predefined classifications of driving behavior and assigning the first discrete segment of the driving behavior associated with the vehicle to the selected first predefined classification of driving behavior;
classifying, by the telematics computing system based on the analyzing of the aggregated telematics data, the second discrete segment of the driving behavior associated with the vehicle by selecting a second predefined classification of driving behavior from an array of predefined classifications of driving behavior and assigning the second discrete segment of the driving behavior associated with the vehicle to the selected second predefined classification of driving behavior;
assigning, by the telematics computing system based on the analyzing of the aggregated telematics data, a first non-zero value weighting factor to the selected first predefined classification of driving behavior;
assigning, by the telematics computing system based on the analyzing of the aggregated telematics data, a second non-zero value weighting factor to the selected first predefined classification of driving behavior; and
generating, by the telematics computing system, a representation of the driving behavior that includes data representative of
the array of predefined classifications of driving behavior,
the first non-zero value weighting factor assigned to the selected first predefined classification of driving behavior,
the second non-zero value weighting factor assigned to the selected second predefined classification of driving behavior, and
zero value weighting factors assigned to a remainder of predefined classifications of driving behavior included in the array of predefined classifications of driving behavior.

13. The method of claim 12, embodied as computer-executable instructions on at least one non-transitory computer-readable medium.

14. A system comprising:
at least one physical computing device that:
collects telematics data from a telematics device associated with a vehicle;
aggregates the telematics data collected over time from the telematics device associated with the vehicle;
analyzes the aggregated telematics data to determine a set of discrete segments of driving behavior associated with the vehicle;
classifies the set of discrete segments of the driving behavior associated with the vehicle based on the analyzing of the aggregated telematics data; and
generates a representation of the driving behavior based on the classifying of the set of discrete segments of the driving behavior, the generated representation of the driving behavior including weighting factors assigned to the classified set of discrete segments of the driving behavior.

15. The system of claim 14, wherein the at least one physical computing device classified the set of discrete segments of the driving behavior associated with the vehicle by:
selecting predefined classifications of driving behavior from an array of predefined classifications of driving behavior; and
assigning the set of discrete segments of the driving behavior associated with the vehicle to the selected predefined classifications of driving behavior.

16. The system of claim 15, wherein the generated representation of the driving behavior includes data representative of the array of predefined classifications of driving behavior.

17. The system of claim 16, wherein:
the weighting factors assigned to the classified set of discrete segments of the driving behavior comprise non-zero value weighting factors assigned to the selected predefined classifications of driving behavior to which the set of discrete segments of the driving behavior associated with the vehicle are assigned; and
the generated representation of the driving behavior further includes data representative of zero value weighting factors assigned to other predefined classifications of driving behavior included in the array of predefined classifications of driving behavior and to which the set of discrete segments of the driving behavior associated with the vehicle are not assigned.

18. The system of claim 14, wherein the weighting factors assigned to the classified set of discrete segments of the driving behavior represent ratios between the discrete segments included in the classified set of discrete segments of the driving behavior.

19. The system of claim 14, wherein the telematics device includes a dedicated telematics device that is communicatively coupled to an operating system of the vehicle.

20. The system of claim 14, wherein the telematics device includes a mobile communications device associated with the insurance policy holder.
